(19) United States
(12) Patent Application Publication
(10) Pub. No.: US 2026/0155920 A1
(43) Pub. Date: Jun. 4, 2026

(54) INTEGRATED MILLIMETER-WAVE WIRELESS LOCAL AREA NETWORK SYSTEMS, AND APPARATUSES, METHODS, AND COMPUTER-READABLE STORAGE MEDIA THEREOF

(71) Applicant: Huawei Technologies Co., Ltd., Shenzhen (CN)

(72) Inventors: Yan Xin, Kanata (CA); Jung Hoon Suh, Ottawa (CA); Osama Aboul-Magd, Ottawa (CA); Kwok Shum Au, Ottawa (CA)

(21) Appl. No.: 19/458,422

(22) Filed: Jan. 23, 2026

Related U.S. Application Data
(63) Continuation of application No. PCT/CN2024/103626, filed on Jul. 4, 2024.
(60) Provisional application No. 63/529,566, filed on Jul. 28, 2023.

(51) Int. Cl. H04L 5/00; H04W 72/0453

(52) U.S. Cl. CPC H04L 5/0007; H04L 5/0046; H04W 72/0453

(57) ABSTRACT

A communication method has the step of transmitting a signal in a millimeter wave (MMW) band to a device using a resource unit (RU) in an orthogonal frequency-division multiple access (OFDMA) physical layer protocol data unit (PPDU). The RU is one of a plurality of RUs of the OFDMA PPDU. The plurality of RUs are on the opposite frequency sides of one or more direct-current (DC) subcarriers. Each RU of the plurality of RUs is a 26-subcarrier group, or is partitionable to a plurality of 26-subcarrier groups interleaved with a plurality of null-subcarrier groups, each of the plurality of 26-subcarrier groups or a combination of the plurality of 26-subcarrier groups usable as a separate RU.

### CROSS-REFERENCE TO RELATED APPLICATIONS

This application is a continuation of International Application No. PCT/CN2024/103626, filed Jul. 4, 2024, which claims the benefit of U.S. Provisional Patent Application No. 63/529,566, filed Jul. 28, 2023, applications of which are incorporated herein by reference in their entirety.

### FIELD OF THE DISCLOSURE

The present disclosure relates generally to wireless local area network (WLAN) systems, and in particular to integrated millimeter-wave WLAN systems, and apparatuses, methods, and computer-readable storage media thereof.

### BACKGROUND

Wireless communications are known. For example, IEEE 802.11 standard series specify a group of standardized wireless communication technologies for wireless local area network (WLAN). Among these standards, IEEE 802.11ad/ay standards (as specified in IEEE P802.11-REVme/D3.0) have been specified for WLAN systems operating over unlicensed millimeter wave (MMW) band in which the US communications regulation authority FCC allocates a total of 14 Gigahertz (GHz) radio spectrum within 57 GHz to 71 GHz for unlicensed applications including WLAN. In general, this band is called 60 GHz band.

Although the adoption of millimeter wave (MMW) can significantly increase system throughputs in order to meet high demand data rate requirements, 802.11ad/ay standards are designed to be incompatible with the WLAN standards such as 802.11n/ac/ax/be standards operating in the sub-7 GHz bands (that is, frequency bands below 7 GHZ). 802.11n/ac/ax/be standards either have been or are foreseen to be widely deployed for ubiquitous applications. It is desirable (for example, as described in IEEE 802.11-22/1595r1) to integrate sub-7 GHZ WLAN into MMW WLAN, in which the operation solutions adopted in sub-7 GHZ WLAN (e.g., architecture, modem/PHY, MAC, and software) can be reused as much as possible to minimize the complexity and to reduce design/validation efforts.

Recently, the IEEE 802.11 Working Group has approved “to form an IEEE 802.11 integrated mmWave (IMMW) Study Group for a new IEEE 802.11 MAC/PHY amendment which specifies carrier frequency operation between 42.5 and 71 GHz and leverages IEEE 802.11 MAC/PHY specifications in the Sub 7 GHz bands.”

### SUMMARY

Embodiments disclosed herein relate to various aspects such as channelization, subcarrier spacing, tone plans of resource allocation (such as resource units (RUs)), and guard interval (GI) for orthogonal frequency-division multiplexing (OFDM) symbols in integrated mmWave (IMMW) WLAN.

According to one aspect of this disclosure, there is provided a communication method comprising: transmitting or receiving a signal in a millimeter wave (MMW) band to a device using a resource unit (RU) in an orthogonal frequency-division multiple access (OFDMA) physical layer protocol data unit (PPDU); the RU is one of a plurality of RUs of the OFDMA PPDU; the plurality of RUs are on the opposite frequency sides of one or more direct-current (DC) subcarriers; and each RU of the plurality of RUs is a 26-subcarrier group, or is partitionable to a plurality of 26-subcarrier groups separated by a plurality of null-subcarrier groups, each of the plurality of 26-subcarrier groups or a combination of the plurality of 26-subcarrier groups usable as a separate RU.

In some embodiments, the plurality of RUs are defined in one or more standards.

In some embodiments, the plurality of RUs are in a zero decibels relative to reference level (dBr) region of the MMW band.

In some embodiments, each of the plurality of null-subcarrier groups contains two subcarriers.

In some embodiments, each neighboring pair of the plurality of null-subcarrier groups are spaced by one or more 26-subcarrier groups of the plurality of 26-subcarrier groups.

In some embodiments, the MMW band has a bandwidth of 540 Megahertz (MHz), and the OFDMA has a sampling rate of 640 MHz, a discrete Fourier transform (DFT) size of 256, and a subcarrier spacing of 2.5 MHz; and the plurality of RUs contain 156 subcarriers on the opposite frequency sides of three DC subcarriers and partitionable to two 52-subcarrier groups and two 26-subcarrier groups, or a total number of the plurality of RUs and the one or more DC subcarriers is less than or equal to 188.

In some embodiments, the signal comprises an OFDM symbol and a guard interval having a length selected from a group of eight, 16, 32, and 64.

In some embodiments, the MMW band has a bandwidth of 1080 MHz, and the OFDMA has a sampling rate of 1280 MHz, a DFT size of 512, and a subcarrier spacing of 2.5 MHz; and the plurality of RUs contain 346 subcarriers on the opposite frequency sides of three DC subcarriers and partitionable to two 52-subcarrier groups and one 242-subcarrier group, or a total number of the plurality of RUs and the one or more DC subcarriers is less than or equal to 376.

In some embodiments, signal comprises an OFDM symbol and a guard interval having a length selected from a group of 16, 32, 64, and 128.

In some embodiments, the MMW band has a bandwidth of 2160 MHz, and the OFDMA has a sampling rate of 2560 MHz, a DFT size of 1024, and a subcarrier spacing of 2.5 MHz; and the plurality of RUs contain 726 subcarriers on the opposite frequency sides of three DC subcarriers and partitionable to three 242-subcarrier groups, the plurality of RUs contain 696 subcarriers on the opposite frequency sides of five DC subcarriers and partitionable to two 106-subcarrier groups and one 484-subcarrier group, or a total number of the plurality of RUs and the one or more DC subcarriers is less than or equal to 752.

In some embodiments, signal comprises an OFDM symbol and a guard interval having a length selected from a group of 32, 64, 128, and 256.

In some embodiments, the MMW band has a bandwidth of 4320 MHz, and the OFDMA has a sampling rate of 5180 MHz, a DFT size of 2048, and a subcarrier spacing of 2.5 MHz; and the plurality of RUs contain 1584 subcarriers on the opposite frequency sides of five DC subcarriers and partitionable to two 52-subcarrier groups, two 242-subcarrier groups, and one 996-subcarrier group, the plurality of RUs contain 1452 subcarriers on the opposite frequency sides of at least three DC subcarriers and partitionable to two 726-subcarrier groups, the plurality of RUs contain 1392 subcarriers on the opposite frequency sides of at least three DC subcarriers and partitionable to two 696-subcarrier groups, or a total number of the plurality of RUs and the one or more DC subcarriers is less than or equal to 1616.

In some embodiments, signal comprises an OFDM symbol and a guard interval having a length selected from a group of 64, 128, 256, and 512.

In some embodiments, the MMW band has a bandwidth of 6480 MHz, and the OFDMA has a sampling rate of 7680 MHz, a DFT size of 3072, and a subcarrier spacing of 2.5 MHz; and the plurality of RUs contain 2446 subcarriers on the opposite frequency sides of three DC subcarriers and partitionable to two 106-subcarrier groups, one 242-subcarrier group, and two 996-subcarrier groups, the plurality of RUs contain 2440 subcarriers on the opposite frequency sides of five DC subcarriers and partitionable to two 26-subcarrier groups, four 106-subcarrier groups, two 484-subcarrier groups, and one 996-subcarrier group, the plurality of RUs contain 2178 subcarriers on the opposite frequency sides of three DC subcarriers and partitionable to three 726-subcarrier groups, the plurality of RUs contain 2088 subcarriers on the opposite frequency sides of five DC subcarriers and partitionable to three 696-subcarrier groups, or a total number of the plurality of RUs and the one or more DC subcarriers is less than or equal to 2480.

In some embodiments, signal comprises an OFDM symbol and a guard interval having a length selected from a group of 96, 192, 384, and 768.

In some embodiments, the MMW band has a bandwidth of 8640 MHz, and the OFDMA has a sampling rate of 10240 MHz, a DFT size of 4096, and a subcarrier spacing of 2.5 MHz; and the plurality of RUs contain 3304 subcarriers on the opposite frequency sides of five DC subcarriers and partitionable to two 52-subcarrier groups, two 106-subcarrier groups, and three 996-subcarrier groups, the plurality of RUs contain 2904 subcarriers on the opposite frequency sides of at least three DC subcarriers and partitionable to four 726-subcarrier groups, the plurality of RUs contain 2784 subcarriers on the opposite frequency sides of at least three DC subcarriers and partitionable to four 696-subcarrier groups, or a total number of the plurality of RUs and the one or more DC subcarriers is less than or equal to 3344.

In some embodiments, signal comprises an OFDM symbol and a guard interval having a length selected from a group of 128, 256, 512, and 1024.

In some embodiments, the MMW band has a bandwidth of 540 MHz, and the OFDMA has a sampling rate of 640 MHz, a DFT size of 128, and a subcarrier spacing of 5 MHz; and the plurality of RUs contain 78 subcarriers on the opposite frequency sides of three DC subcarriers and partitionable to three 26-subcarrier groups, or a total number of the plurality of RUs and the one or more DC subcarriers is less than or equal to 94.

In some embodiments, the signal comprises an OFDM symbol and a guard interval having a length selected from a group of eight, 16, 32, and 64.

In some embodiments, the MMW band has a bandwidth of 1080 MHz, and the OFDMA has a sampling rate of 1280 MHz, a DFT size of 256, and a subcarrier spacing of 5 MHz; and the plurality of RUs contain 156 subcarriers on the opposite frequency sides of at least three DC subcarriers and partitionable to two 52-subcarrier groups and two 26-subcarrier groups, or a total number of the plurality of RUs and the one or more DC subcarriers is less than or equal to 188.

In some embodiments, the signal comprises an OFDM symbol and a guard interval having a length selected from a group of 16, 32, 64, and 96.

In some embodiments, the MMW band has a bandwidth of 2160 MHz, and the OFDMA has a sampling rate of 2560 MHz, a DFT size of 512, and a subcarrier spacing of 5 MHz; and the plurality of RUs contain 346 subcarriers on the opposite frequency sides of three DC subcarriers and partitionable to two 52-subcarrier groups and one 242-subcarrier group, or a total number of the plurality of RUs and the one or more DC subcarriers is less than or equal to 376.

In some embodiments, the signal comprises an OFDM symbol and a guard interval having a length selected from a group of 32, 64, 128, and 192.

In some embodiments, the MMW band has a bandwidth of 4320 MHz, and wherein the OFDMA has a sampling rate of 5180 MHz, a DFT size of 1024, and a subcarrier spacing of 5 MHz; and the plurality of RUs contain 778 subcarriers on the opposite frequency sides of three DC subcarriers and partitionable to three 242-subcarrier groups and two 26-subcarrier groups, the plurality of RUs contain 748 subcarriers on the opposite frequency sides of five DC subcarriers and partitionable to two 26-subcarrier groups, two 106-subcarrier groups, and one 484-subcarrier group, the plurality of RUs contain 692 subcarriers on the opposite frequency sides of at least three DC subcarriers and partitionable to two 346-subcarrier groups, or a total number of the plurality of RUs and the one or more DC subcarriers is less than or equal to 808.

In some embodiments, the signal comprises an OFDM symbol and a guard interval having a length selected from a group of 64, 128, 256, and 384.

In some embodiments, the MMW band has a bandwidth of 6480 MHz, and the OFDMA has a sampling rate of 7680 MHz, a DFT size of 1536, and a subcarrier spacing of 5 MHz; and the plurality of RUs contain 1208 subcarriers on the opposite frequency sides of five DC subcarriers and partitionable to two 106-subcarrier groups and one 996-subcarrier group, the plurality of RUs contain 1038 subcarriers on the opposite frequency sides of three DC subcarriers and partitionable to three 346-subcarrier groups, or a total number of the plurality of RUs and the one or more DC subcarriers is less than or equal to 1240.

In some embodiments, the signal comprises an OFDM symbol and a guard interval having a length selected from a group of 96, 192, 384, and 576.

In some embodiments, the MMW band has a bandwidth of 8640 MHz, and the OFDMA has a sampling rate of 10240 MHz, a DFT size of 2048, and a subcarrier spacing of 5 MHz; and the plurality of RUs contain 1636 subcarriers on the opposite frequency sides of five DC subcarriers and partitionable to two 26-subcarrier groups, two 52-subcarrier groups, two 242-subcarrier groups, and one 996-subcarrier group, the plurality of RUs contain four 346-subcarrier groups on the opposite frequency sides of at least three DC subcarriers, or a total number of the plurality of RUs and the one or more DC subcarriers is less than or equal to 1672.

In some embodiments, the signal comprises an OFDM symbol and a guard interval having a length selected from a group of 128, 256, 512, and 768.

In some embodiments, the MMW band has a bandwidth of 540 MHz, and the OFDMA has a sampling rate of 640 MHz, a DFT size of 512, and a subcarrier spacing of 1.25 MHz; and the plurality of RUs contain 346 subcarriers on the opposite frequency sides of three DC subcarriers and partitionable to two 52-subcarrier groups and one 242-subcarrier group, or a total number of the plurality of RUs and the one or more DC subcarriers is less than or equal to 376.

In some embodiments, the signal comprises an OFDM symbol and a guard interval having a length selected from a group of eight, 16, 32, and 64.

In some embodiments, the MMW band has a bandwidth of 1080 MHz, and the OFDMA has a sampling rate of 1280 MHz, a DFT size of 1024, and a subcarrier spacing of 1.25 MHz; and the plurality of RUs contain 726 subcarriers on the opposite frequency sides of three DC subcarriers and partitionable to three 242-subcarrier groups, the plurality of RUs contain 696 subcarriers on the opposite frequency sides of five DC subcarriers and partitionable to two 106-subcarrier groups and one 484-subcarrier group, the plurality of RUs contain 692 subcarriers partitionable to two 346-subcarrier groups, or a total number of the plurality of RUs and the one or more DC subcarriers is less than or equal to 752.

In some embodiments, the signal comprises an OFDM symbol and a guard interval having a length selected from a group of 16, 32, 64, and 128.

In some embodiments, the MMW band has a bandwidth of 2160 MHz, and the OFDMA has a sampling rate of 2560 MHz, a DFT size of 2048, and a subcarrier spacing of 1.25 MHz; and the plurality of RUs contain 1480 subcarriers on the opposite frequency sides of five DC subcarriers and partitionable to two 242-subcarrier groups and one 996-subcarrier group, the plurality of RUs contain 1452 subcarriers on the opposite frequency sides of at least three DC subcarriers and partitionable to two 726-subcarrier groups, the plurality of RUs contain 1384 subcarriers on the opposite frequency sides of at least three DC subcarriers and partitionable to four 346-subcarrier groups, or a total number of the plurality of RUs and the one or more DC subcarriers is less than or equal to 1504.

In some embodiments, the signal comprises an OFDM symbol and a guard interval having a length selected from a group of 32, 64, 128, and 256.

In some embodiments, the MMW band has a bandwidth of 4320 MHz, and the OFDMA has a sampling rate of 5180 MHz, a DFT size of 4096, and a subcarrier spacing of 1.25 MHz; and the plurality of RUs contain 3200 subcarriers on the opposite frequency sides of five DC subcarriers and partitionable to two 106-subcarrier groups and three 996-subcarrier groups, the plurality of RUs contain 2904 subcarriers on the opposite frequency sides of at least three DC subcarriers and partitionable to four 726-subcarrier groups, the plurality of RUs contain 2960 subcarriers on the opposite frequency sides of at least three DC subcarriers and partitionable to two 1480-subcarrier groups, or a total number of the plurality of RUs and the one or more DC subcarriers is less than or equal to 3232.

In some embodiments, the signal comprises an OFDM symbol and a guard interval having a length selected from a group of 64, 128, 256, and 512.

In some embodiments, the MMW band has a bandwidth of 6480 MHz, and the OFDMA has a sampling rate of 7680 MHz, a DFT size of 6144, and a subcarrier spacing of 1.25 MHz; and the plurality of RUs contain 4922 subcarriers on the opposite frequency sides of three DC subcarriers and partitionable to two 106-subcarrier groups, three 242-subcarrier group, and four 996-subcarrier groups, the plurality of RUs contain 4440 subcarriers on the opposite frequency sides of five DC subcarriers and partitionable to three 1480-subcarrier group, or a total number of the plurality of RUs and the one or more DC subcarriers is less than or equal to 4960.

In some embodiments, the signal comprises an OFDM symbol and a guard interval having a length selected from a group of 96, 192, 384, and 768.

In some embodiments, the MMW band has a bandwidth of 8640 MHz, and the OFDMA has a sampling rate of 10240 MHz, a DFT size of 8192, and a subcarrier spacing of 1.25 MHz; and the plurality of RUs contain 6672 subcarriers on the opposite frequency sides of at least three DC subcarriers and partitionable to two 106-subcarrier groups, two 242-subcarrier groups, and six 996-subcarrier groups, the plurality of RUs contain four 1480-subcarrier groups on the opposite frequency sides of five DC subcarriers, or a total number of the plurality of RUs and the one or more DC subcarriers is less than or equal to 6688.

In some embodiments, the signal comprises an OFDM symbol and a guard interval having a length selected from a group of 128, 256, 512, and 1024.

In some embodiments, the MMW band has a bandwidth of 540 MHz, and the OFDMA has a sampling rate of 640 MHz, a DFT size of 1024, and a subcarrier spacing of 0.625 MHz; and the plurality of RUs contain 726 subcarriers on the opposite frequency sides of three DC subcarriers and partitionable to three 242-subcarrier groups, the plurality of RUs contain 696 subcarriers on the opposite frequency sides of five DC subcarriers and partitionable to two 106-subcarrier groups and one 484-subcarrier group, or a total number of the plurality of RUs and the one or more DC subcarriers is less than or equal to 752.

In some embodiments, the signal comprises an OFDM symbol and a guard interval having a length selected from a group of 8, 16, 32, and 64.

In some embodiments, the MMW band has a bandwidth of 1080 MHz, and the OFDMA has a sampling rate of 1280 MHz, a DFT size of 2048, and a subcarrier spacing of 0.625 MHz; and the plurality of RUs contain 1480 subcarriers on the opposite frequency sides of five DC subcarriers and partitionable to two 242-subcarrier groups and one 996-subcarrier group, the plurality of RUs contain 1452 subcarriers on the opposite frequency sides of at least three DC subcarriers and partitionable to two 726-subcarrier groups, or a total number of the plurality of RUs and the one or more DC subcarriers is less than or equal to 1504.

In some embodiments, the signal comprises an OFDM symbol and a guard interval having a length selected from a group of 16, 32, 64, and 128.

In some embodiments, the MMW band has a bandwidth of 2160 MHz, and the OFDMA has a sampling rate of 2560 MHz, a DFT size of 4096, and a subcarrier spacing of 0.625 MHz; and the plurality of RUs contain 2988 subcarriers on the opposite frequency sides of five DC subcarriers and partitionable to three 996-subcarrier groups, the plurality of RUs contain 2960 subcarriers on the opposite frequency sides of at least three DC subcarriers and partitionable to two 1480-subcarrier groups, or a total number of the plurality of RUs and the one or more DC subcarriers is less than or equal to 3008.

In some embodiments, the signal comprises an OFDM symbol and a guard interval having a length selected from a group of 32, 64, 128, and 256.

In some embodiments, the MMW band has a bandwidth of 4320 MHz, and the OFDMA has a sampling rate of 5180 MHz, a DFT size of 8192, and a subcarrier spacing of 0.625 MHz; and the plurality of RUs contain 6444 subcarriers on the opposite frequency sides of at least three DC subcarriers and partitionable to two 26-subcarrier groups, eight 52-subcarrier groups, and six 996-subcarrier groups, the plurality of RUs contain 5976 subcarriers on the opposite frequency sides of at least three DC subcarriers and partitionable to two 2988-subcarrier groups, or a total number of the plurality of RUs and the one or more DC subcarriers is less than or equal to 6464.

In some embodiments, the signal comprises an OFDM symbol and a guard interval having a length selected from a group of 64, 128, 256, and 512.

In some embodiments, the MMW band has a bandwidth of 6480 MHz, and the OFDMA has a sampling rate of 7680 MHz, a DFT size of 16384, and a subcarrier spacing of 0.625 MHz; and the plurality of RUs contain 9868 subcarriers partitionable to four 52-subcarrier groups, two 106-subcarrier groups, two 242-subcarrier groups, and nine 996-subcarrier groups, or a total number of the plurality of RUs and the one or more DC subcarriers is less than or equal to 9920.

In some embodiments, the signal comprises an OFDM symbol and a guard interval having a length selected from a group of 96, 192, 384, and 768.

In some embodiments, the MMW band has a bandwidth of 8640 MHz, and the OFDMA has a sampling rate of 10240 MHz, a DFT size of 32768, and a subcarrier spacing of 0.625 MHz; and the plurality of RUs contain 13368 subcarriers on the opposite frequency sides of five DC subcarriers and partitionable to four 52-subcarrier groups, two 106-subcarrier groups, and thirteen 996-subcarrier groups, the plurality of RUs contain 13360 subcarriers on the opposite frequency sides of at least three DC subcarriers and partitionable to two 6444-subcarrier groups, two 106-subcarrier groups, four 52-subcarrier groups, and two 26-subcarrier groups, or a total number of the plurality of RUs and the one or more DC subcarriers is less than or equal to 13376.

In some embodiments, the signal comprises an OFDM symbol and a guard interval having a length selected from a group of 128, 256, 512, and 1024.

According to one aspect of this disclosure, there is provided a module comprising: one or more circuits for performing the above-described method.

According to one aspect of this disclosure, there is provided one or more processors functionally connected to one or more memories for performing the above-described method.

According to one aspect of this disclosure, there is provided an apparatus comprising: one or more processors functionally connected to one or more memories for performing the above-described method.

According to one aspect of this disclosure, there is provided an apparatus configured to perform the above-described method.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform the above-described method.

According to one aspect of this disclosure, there is provided one or more computer-readable storage media storing a computer program, wherein, when the computer program is executed by an apparatus, the apparatus is enabled to implement the above-described method.

According to one aspect of this disclosure, there is provided a computer program product including one or more instructions, wherein, when the instructions are executed by an apparatus, the apparatus is enabled to implement the above-described method.

According to one aspect of this disclosure, there is provided a computer program, wherein, when the computer program is executed by a computer, an apparatus is enabled to implement the above-described method.

According to one aspect of this disclosure, there is provided a communication system comprising a communication node for performing the above-described method.

According to one aspect of this disclosure, there is provided an apparatus for implementing the method in any possible implementation of the foregoing aspects.

With the various tone plans and GI lengths for IMMW disclosed herein, the above-described methods allow reuse of IEEE 802.11be RU tone plan to integrate IMMW with sub-7 GHz WLAN and ensure co-existence of IMMW with 802.11ay and 802.11bf to minimize inter-channel interference.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a diagram showing resource unit (RU) allocations (including 26-, 52-, 106-, 242-, 484- and 996-tone) in an 80 megahertz (MHz) extremely high throughput (EHT) physical layer protocol data unit (PPDU), wherein each of RUs includes data subcarriers and pilot subcarriers;

FIG. 5 is a diagram showing the transmit spectrum mask and 996-tone RU for 80 MHz PPDU in IEEE 802.11be standard;

FIG. 6 is a diagram showing the channelization used by enhanced directional multi-gigabit (EDMG) stations (STAs);

FIG. 7 is a diagram showing the tone allocation for 2.16 GHz PPDU transmission in IEEE 802.11ay standard;

FIG. 8 is a diagram showing the tone allocation for 1.08 GHz PPDU transmission in IEEE 802.11aj standard;

FIG. 9 is a schematic diagram showing the formation of a guard interval in an OFDM symbol;

FIG. 10A shows the transmitter (Tx) spectral mask for channel bandwidth (BW) of 2.16 GHz and the number of tones that may be allocated within the zero (0) decibels relative to reference level (dBr) region and reuse the RU tone plans defined in IEEE 802.11be standard;

FIG. 10B shows the Tx spectral mask for channel BW of 4.32 GHz and the number of tones that may be allocated within the zero (0) dBr region and reuse the RU tone plans defined in IEEE 802.11be standard;

FIG. 10C shows the Tx spectral mask for channel BW of 6.48 GHz and the number of tones that may be allocated within the zero (0) dBr region and reuse the RU tone plans defined in IEEE 802.11be standard;

FIG. 10D shows the Tx spectral mask for channel BW of 8.64 GHz and the number of tones that may be allocated within the zero (0) dBr region and reuse the RU tone plans defined in IEEE 802.11be standard;

FIG. 10E shows the Tx spectral mask for channel BW of 1.08 GHz and the number of tones that may be allocated within the zero (0) dBr region and reuse the RU tone plans defined in IEEE 802.11be standard; and

FIG. 10F shows the Tx spectral mask for channel BW of 0.54 GHz and the number of tones that may be allocated within the zero (0) dBr region and reuse the RU tone plans defined in IEEE 802.11be standard.

### DETAILED DESCRIPTION

Embodiments disclosed herein relate to wireless systems, apparatuses, and methods using millimeter-wave signals. The wireless systems, apparatuses, and methods disclosed herein may be any suitable systems, apparatuses, and methods for transmitting wireless signals. Examples of such systems may be WI-FI® systems (WI-FI is a registered trademark of Wi-Fi Alliance, Austin, TX, USA), 5G or 6G wireless mobile communication systems, and the like.

a. System Structure

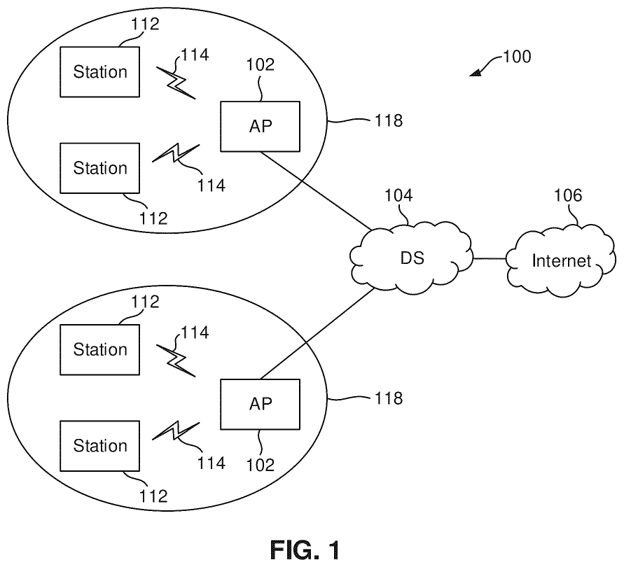

Turning now to FIG. 1, a communication system according to some embodiments of this disclosure is shown and is generally identified using reference numeral 100. As an example, the communication system 100 may be a WI-FI® system built under relevant standards such as IEEE 802.11 standards. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

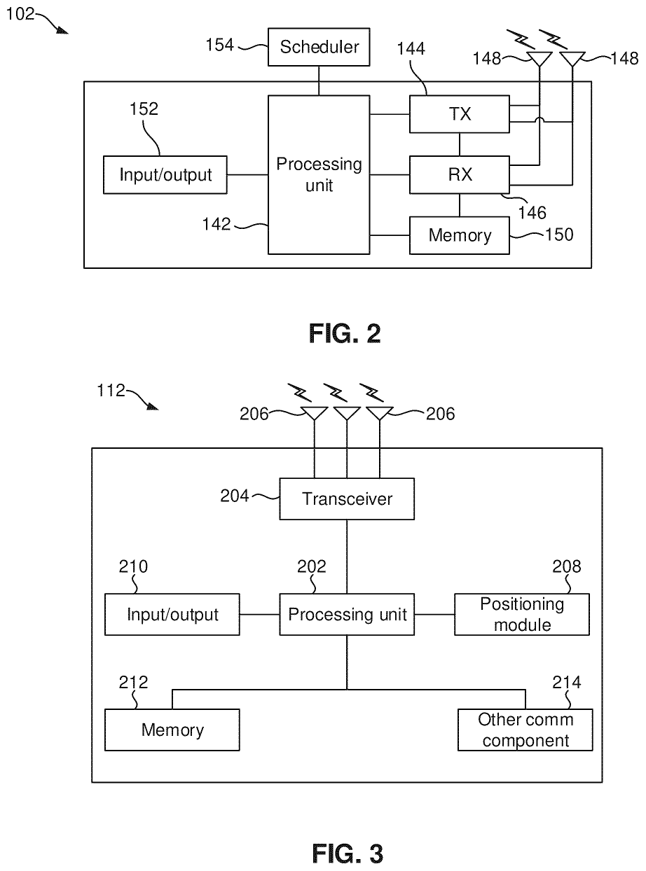

FIG. 2 is a simplified schematic diagram of an AP 102. As shown, the AP 102 comprises at least one processing unit 142, at least one transmitter (Tx) 144, at least one receiver (Rx) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

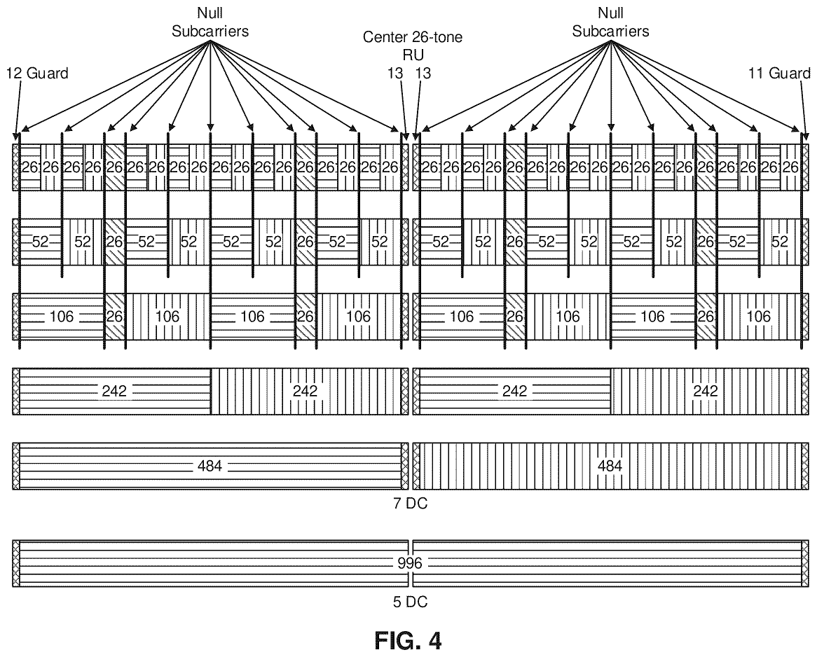

FIG. 3 is a simplified schematic diagram of a STA 112. As shown, the STA 112 comprises at least one processing unit 202, at least one transceiver 204, at least one antenna or network interface controller (NIC) 206, at least one positioning module 208, one or more input/output components 210, at least one memory 212, and at least one other communication component 214.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD R microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the STA 112. The navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the STA 112.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink and the wireless channel used therefor is denoted an uplink channel. A transmission from the AP 102 to the STA 112 is usually denoted a downlink and the wireless channel used therefor is denoted a downlink channel. Suitable modulation technologies may be used for communication between the AP 102 and the STA 112. For example, in some embodiments, orthogonal frequency-division multiplexing (OFDM) may be used wherein the channel 114 is partitioned into a plurality orthogonal subchannels for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. Comparison of IEEE 802.11 Standards

In OFDM, an OFDM symbol includes a group of subcarriers (tones) in the frequency domain. Subcarrier spacing is equal to an OFDM sample rate divided by the discrete Fourier transform (DFT) size (that is, the length thereof). In IEEE 802.11be, an OFDM sample rate equals the correspondent channel bandwidth while in IEEE 802.11ay or IEEE 802.11aj, oversampling is performed, in which an OFDM sample rate is higher than the correspondent channel bandwidth.

Resource unit (RU) is a subgroup of subcarriers of an OFDM symbol as an allocation of subcarriers for data transmission. IEEE 802.11be specifies multi-RU (MRU) transmissions permitting multiple RUs to be allocated to a single user for data transmission.

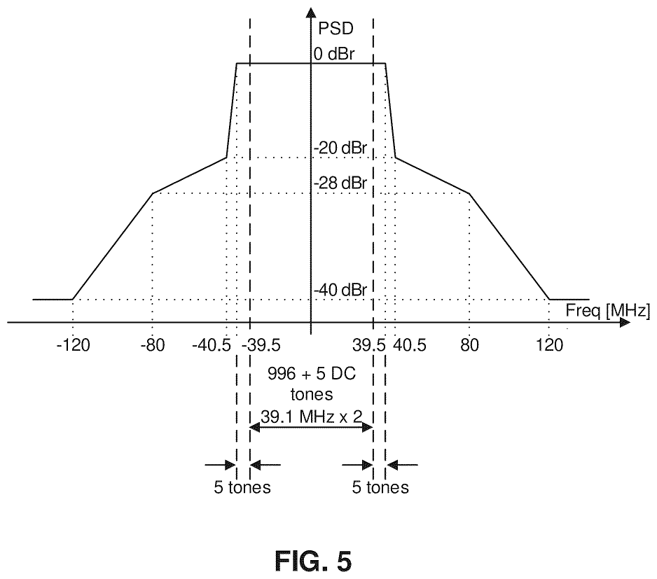

FIG. 4 shows the RU allocations (including 26-, 52-, 106-, 242-, 484- and 996-tone) in an 80 megahertz (MHz) extremely high throughput (EHT) physical (PHY) layer protocol data unit (PPDU), wherein each of RUs includes data subcarriers and pilot subcarriers.

Table 1 below provides the comparison of channel bandwidth, OFDM sample rate, subcarrier spacing and RU allocation in IEEE 802.11be, IEEE 802.11ay OFDM mode and IEEE 802.11aj OFDM mode.

TABLE 1
Comparison of IEEE 802.11be, IEEE 802.11ay
OFDM mode and IEEE 802.11aj OFDM mode

| | 802.11be | 802.11ay (OFDM) | 802.11aj (OFDM) |
|---|---|---|---|
| Channel | 20, 40, 80, 160, 320, | 2160, 4320, 6480, | 540, 1080 MHz |
| bandwidth (BW) | 80 + 80 MHz | 8640, 2160 + 2160, | |
| | | 4320 + 4320 MHz | |
| OFDM sample | 20, 40, 80, 160, 320 MHz | pre-EDMG | 660, 1320 MHz |
| rate | | modulated field: 1760 | |
| | | MHz (SC) | |
| | | EDMG modulated: | |
| | | 2640, 5280, 7920, | |
| | | 10560 MHz (11ay | |
| | | OFDM) | |
| Subcarrier | pre-EHT modulated field: | 5.15625 MHz | 2.578125 MHz |
| spacing | 312.5 kilohertz (kHz) | (2640 MHz / 512) | (660 MHz / 256) |
| | (20 MHz / 64) | | |
| | EHT modulated field: | | |
| | 78.125 kHz (20 MHz / 256) | | |
| DFT size (RU | BW = 20 MHz: 256 (242- | BW = 2160 MHz: 512 | BW = 540 MHz: 256 |
| size) | tone) | (355-tone) | (179-tone) |
| [MRU size] | BW = 40 MHz: 512 (484- | BW = 4320 MHz: 1024 | BW = 1080 MHz: 512 |
| | tone) | (773-tone) | (355-tone) |
| | BW = 80 MHz: 1024 (996- | BW = 6480 MHz: 1536 | |
| | tone) | (1193-tone) | |
| | BW = 160 MHz: 2048 | BW = 8640 MHz: | |
| | (2 × 996) | 2048 | |
| | BW = 320 MHz: 4096 | (1611-tone) | |
| | (4 × 996) | | |
| | [52 + 26, 106 + 26] for any | | |
| | BW | | |
| | [484 + 242] for BW >= 80 | | |
| | MHz | | |
| | [996 + 484], | | |
| | [996 + 484 + 242] for | | |
| | BW >= 160 MHz | | |
| | [2 × 996 + 484], [3 × 996], | | |
| | [3 × 996 + 484] for | | |
| | BW >= 320 MHz | | |

IEEE 802.11-22/1595r1 proposes the following for minimizing complexity and easing implementation of MMW WLAN:
reuse existing sub-7 GHz WLAN solutions on PHY layer, media access control (MAC) layer, and software layer as much as possible;
consider PHY design for MMW interface by reusing lower band design with upclocking; performing simple beamforming training sequence; adapting to multi-link operation specified in 802.11be;
consider the operating bandwidths in MMW to be in the range between around 160 MHz and 1280 MHz (e.g., 160/320/640/1280 MHz) and the base (smallest) channel bandwidth in MMW to be 80/160/320 MHz, which are built on lower band channelization with upscaling.

In 3GPP 5G NR cellular standard, multiple types of subcarrier spacing are derived from the 3GPP 4G LTE subcarrier spacing 15 kHz by scaling up 2^{μ}, μ=0, 1, . . . , 6. Therefore, the maximum subcarrier spacing specified in 3GPP 5G NR is 960 kHz.

Table 2 provides a comparison of the subcarrier spacing and transmit center frequency tolerance specified in IEEE 802.11be and IEEE 802.11ay standards and a list of potential subcarrier spacing values that are equal to 2^{p} (p=0, 1, . . . , 6) and potential operating bandwidths (BWs).

TABLE 2
Comparison of the subcarrier spacing of IEEE 802.11be and IEEE
802.11ay standards and list of potential subcarrier spacing and
potential operating channel BW for integrated mmWave (IMMW)

| Subcarrier spacing | | | |
|---|---|---|---|
| | | Potential | |
| | | subcarrier | Potential |
| | | spacing in IMMW | operating BW |
| 802.11be | 802.11ay | (KHz) | (MHz) in IMMW |
| Pre-EHT modulated | 5.15625 MHz | Δ × 2⁰ 78.125 | 640 |
| fields | (=2640 MHz / 512) | Δ × 2¹ 156.25 | 1280 |
| Δ_pre EHT = 312.5 kHz | Tx center frequency | Δ × 2² 312.5 | 2560 |
| (=20 MHz / 64) | tolerance: ±20 parts | Δ × 2³ 625 | 5120 |
| EHT modulated field | per million (ppm) | Δ × 2⁴ 1250 | |
| Δ = 78.125 kHz | Max center frequency error at | Δ × 2⁵ 2500 | |
| (=20 MHz / 256) | 60 GHz: 1200 KHz | Δ × 2⁶ 5000 | |
| Tx center freq. | | | |
| tolerance: ±20 ppm | | | |
| Max center freq. error at | | | |
| 2.4/5/6 GHz: | | | |
| 48/100/120 KHz | | | |

Design of subcarrier spacing needs to consider Tx center frequency tolerance, Doppler shift (mobility) and synchronization procedure, and/or the like.

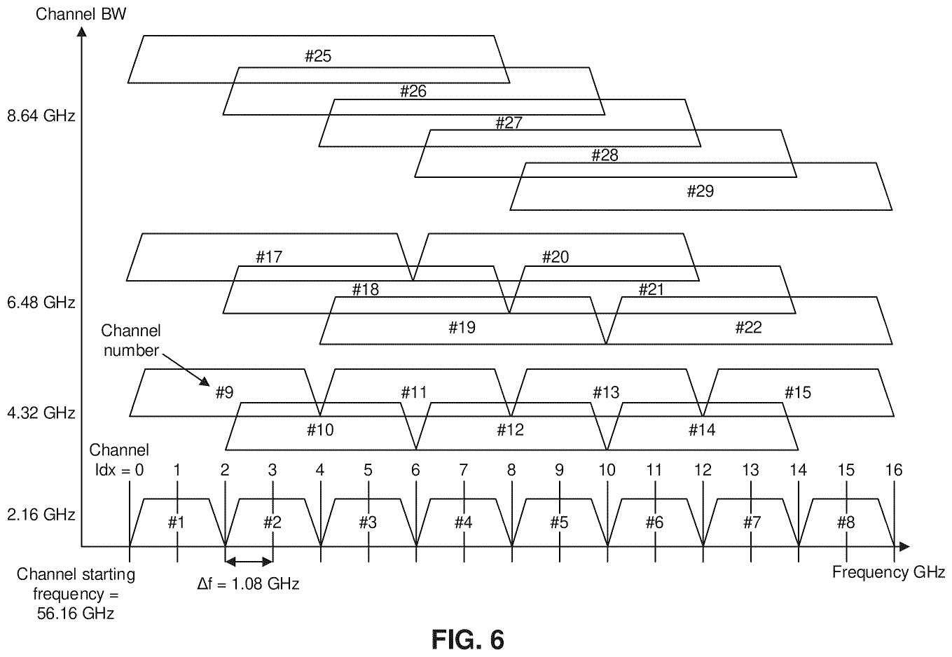

For example, IEEE 802.11be has specified Tx spectral masks for operating BWs of 20, 40 80, 160 and 320 MHz, respectively. FIG. 5 shows an example of Tx spectral mask for an 80 MHz mask PPDU, in which the zero (0) decibel-relative-to-reference-level (dBr) spectrum region (that is, the flat spectrum region) is within (−39.5 MHz, 39.5 MHz) allowing maximum number of 39.5 MHz×2/Δ=1011 tones (wherein subcarrier spacing Δ=78.125 kHz) located in this region. IEEE 802.11be specifies to allocate a 996-tone RU (including data and pilot tones) on an 80 MHz channel and 5 direct-current (DC) tones (that is, the tones around the carrier frequency) are inserted around the carrier frequency.

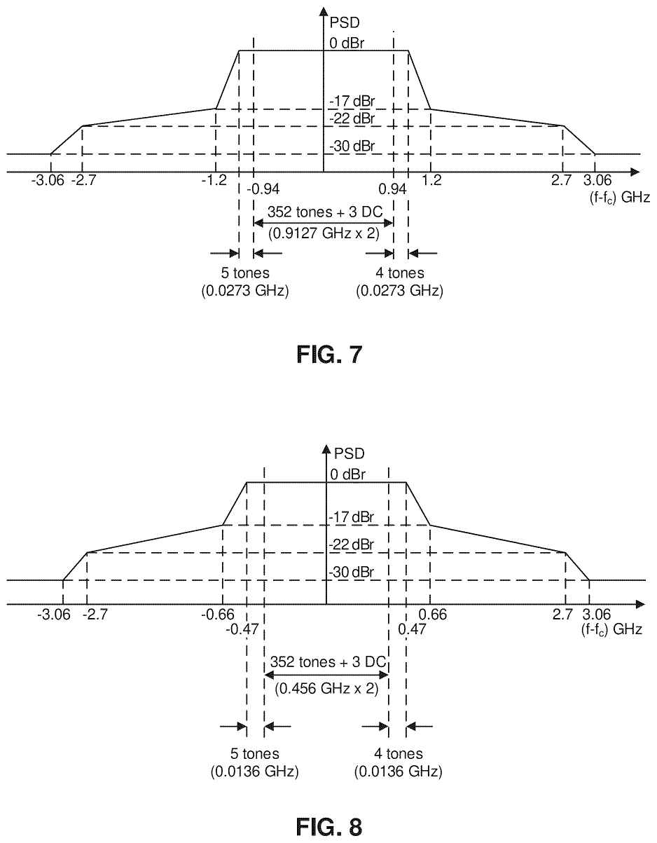

In IEEE 802.11ay, channelization used by enhanced directional multi-gigabit (EDMG) stations (STAs) is specified. For example, FIG. 6 shows the IEEE 802.11ay channelization with base channel width of 2.16 GHz.

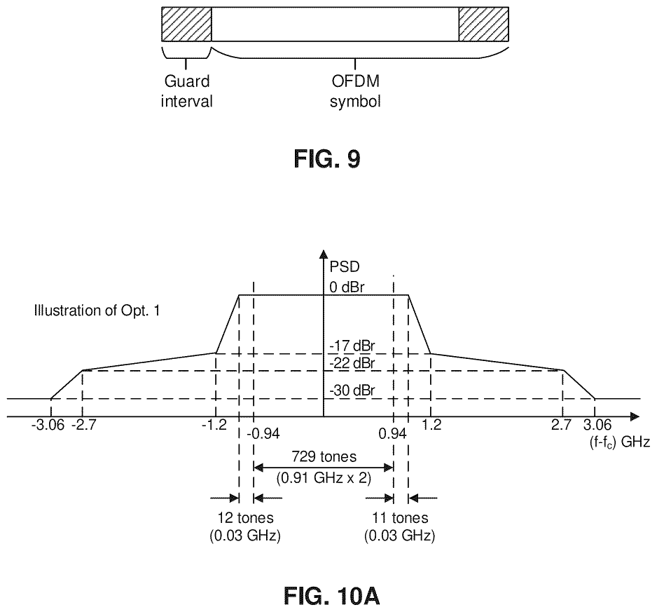

FIG. 7 shows the tone allocation for 2.16 GHz PPDU transmission in IEEE 802.11ay with the following parameters:
sampling rate for BW 2160 MHz: 2640 MHz;
DFT size: 512;

$$\cdot subcarriers spacing \text{:} Δ = 5.15625 MHz ( = 2640 MHz / 512 ) ;$$

maximum number of tones allowed in the 0 dBr region ([−0.94 GHZ, 0.94 GHz]): 940 MHz×2/Δ=364;
For BW=2160 MHz, the total number of data, pilot, and DC tones is 355=336 (data)+16 (pilot)+3 (DC); in IEEE 802.11ay, three (3) DC subcarriers are applied to PPDU transmission of any channel BW.

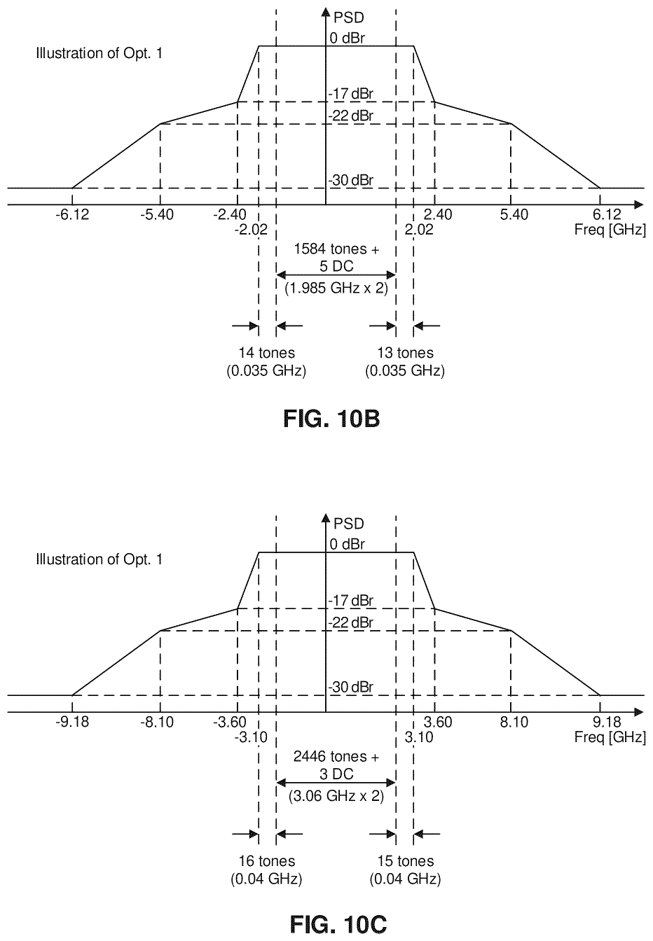

FIG. 8 is a diagram showing the tone allocation for 1.08 GHz PPDU transmission in IEEE 802.11aj standard wherein:
sampling rate of IEEE 11aj is scaled down half of the IEEE 802.11ay sampling rate, that is, 1320 MHz;
DFT size is 512;

$$\cdot subcarriers spacing is Δ = 2.578125 MHz ( = 1320 MHz / 512 ) ;$$

the maximum number of tones allowed in the 0 dBr region [−0.47 GHZ, 0.47 GHz] is 470 MHz×2/Δ=364;
for BW=1080 MHz, the total number of data, pilot, and DC tones is 355=336 (data)+16 (pilot)+3 (DC);
the 0 dBr region of IEEE 802.11aj spectral mask for 1.08 GHz BW is scaled down half from the IEEE 802.11ad/ay 2.16 GHz BW;
IEEE 802.11aj spectral mask for BW=540 MHz is further scaled to half of the one for BW=1080 MHz.

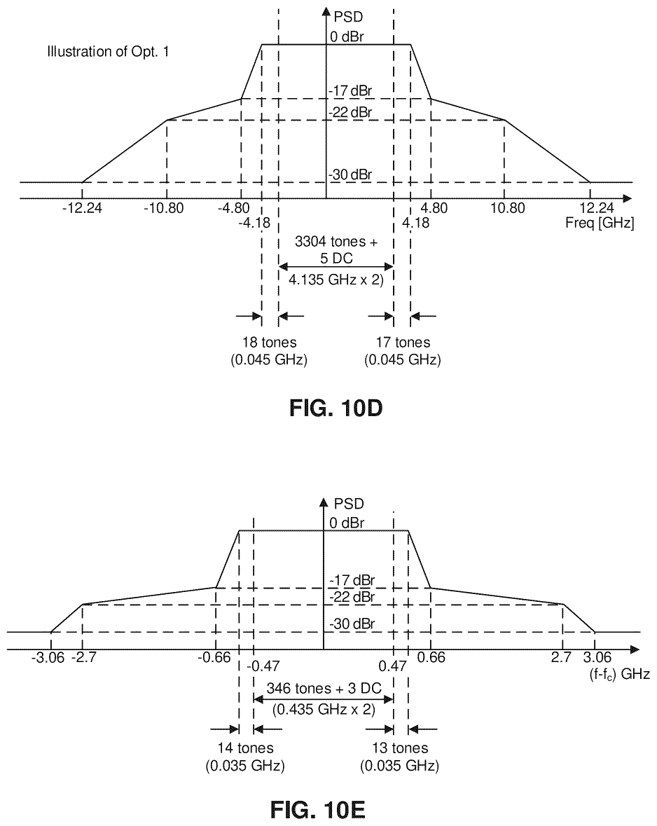

In OFDM, to reduce the inter symbol interference (ISI) caused by the channel delay spread, a cyclic prefix (CP) is added in the time domain. As shown in FIG. 9, in general, a CP is constructed by copying the last part of an OFDM symbol and allocating it in the front of the OFDM symbol. The guard interval (GI) defined in IEEE 802.11 standards is equivalent to the CP.

Table 3 and Table 4 list some EDMG OFDM mode timing related parameters. IEEE 802.11ay (EDMG) and IEEE 802.11be specify three types of GIs for each channel width, respectively, that is, short (GI₁), normal (GI₂) and long (GI₃) GIs to minimize the impact of channel delay spread to OFDM symbols for different channel scenarios. The EDMG GI length and duration are shown in Table 3 and Table 4. The overheads of GIs are evaluated as the percentage of a GI duration vs a related OFDM symbol duration.

TABLE 3
EDMG OFDM mode timing related parameters

| | BW | | | | | | | |
|---|---|---|---|---|---|---|---|---|
| Parameters | 2.16 GHz | | 4.32 GHz | | 6.48 GHz | | 8.64 GHz | |
| Subcarrier frequency | 5.15625 | MHz | 5.15625 | MHz | 5.15625 | MHz | 5.15625 | MHz |
| spacing | | | | | | | | |
| EDMG OFDM sample rate | 2.64 | GHz | 5.28 | GHz | 7.92 | GHz | 10.56 | GHz |

| Discrete Fourier transform | 512 | 1024 | | 1536 | | 2048 | |
|---|---|---|---|---|---|---|---|
| (DFT) size | | | | | | | |
| OFDM Inverse DFT | 0.194 | 0.194 | μs | 0.194 | μs | 0.194 | μs |

| | | | | |
|---|---|---|---|---|
| (IDFT) /DFT period | microsecond | | | |
| | (μs) | | | |
| Short guard interval length / | 48 / 18.18 | 96 / 18.18 | 144 / 18.18 | 192 / 18.18 |
| duration / percentage of | nanosecond | ns / 9.4% | ns / 9.4% | ns / 9.4% |
| GI vs OFDM symbol | (ns) / 9.4% | | | |
| Normal guard interval | 96 / 36.36 ns / | 192 / 36.36 | 288 / 36.36 | 384 / 36.36 |
| length / duration / | 18.7% | ns / 18.7% | ns / 18.7% | ns / 18.7% |
| percentage of GI vs OFDM | | | | |
| symbol | | | | |
| Long guard interval length / | 192 / 72.72 ns / | 384 / 72.72 | 576 / 72.72 | 768 / 72.72 |
| duration / percentage of | 37.5% | ns / 37.5% | ns / 37.5% | ns / 37.5% |
| GI vs OFDM symbol | | | | |

TABLE 4
IEEE 802.11be timing related parameters

| | BW | | | | | | | | | |
|---|---|---|---|---|---|---|---|---|---|---|
| Parameters | 20 MHz | | 40 MHz | | 80 MHz | | 160 MHz | | 320 MHz | |
| Subcarrier frequency | 78.125 | kHz | 78.125 | kHz | 78.125 | kHz | 78.125 | kHz | 78.125 | kHz |
| spacing (EHT modulated | | | | | | | | | | |
| fields) | | | | | | | | | | |
| DFT size | 256 | | 512 | | 1024 | | 2048 | | 4096 | |
| OFDM IDFT/DFT period | 12.8 | μs | 12.8 | μs | 12.8 | μs | 12.8 | μs | 12.8 | μs |

| | | | | | |
|---|---|---|---|---|---|
| (data) | | | | | |
| GI1 (data) length / | 16 / 0.8 | 32 / 0.8 | 64 / 0.8 | 128 / 0.8 | 256 / 0.8 |
| duration / percentage of | μs / 6.25% | μs / 6.25% | μs / 6.25% | μs / 6.25% | μs / 6.25% |
| GI vs OFDM symbol | | | | | |
| GI2 (data) length / | 32 / 1.6 | 64 / 1.6 | 128 / 1.6 | 256 / 1.6 | 512 / 1.6 |
| duration / percentage of | μs / 12.5% | μs / 12.5% | μs / 12.5% | μs / 12.5% | μs / 12.5% |
| GI vs OFDM symbol | | | | | |
| GI4 (data) length / | 64 / 3.2 | 128 / 3.2 | 256 / 3.2 | 512 / 3.2 | 1024 / 3.2 |
| duration / percentage of | μs / 25% | μs / 25% | μs / 25% | μs / 25% | μs / 25% |
| GI vs OFDM symbol | | | | | |

As evaluated in IEEE 802.11ay channel mode, for ultra-short range communication applications, the channel delay spread can be less than 10 nanoseconds (ns). Even shorter GIs IMMW can be considered in IMMW for such applications.

IMMW is a next generation WLAN technology which is proposed to reuse PHY algorithms and MAC protocols in sub-7 GHz WLAN (such as IEEE 802.11be) as much as possible. However, coexistence issue for IMMW with the IEEE 802.11ay and IEEE 802.11be standards needs to be taken into account.

For example, since the channelization for EDMG PPDU transmissions is used by both IEEE 802.11ay and IEEE 802.11bf (that is, WLAN sensing), it is preferable for IMMW to reuse the IEEE 802.11ay channelization to minimize an inter-channel interference if a new channelization for IMMW with a different base operating channel width is used (for example, as proposed in IEEE 802.11-22/1595r1), in which an operating channel in IMMW will cross the boundaries of a base operating channel in 802.11ay and 802.11bf.

IEEE 802.11-22/1595r1 proposes a different channelization from the IEEE 802.11ay channelization, which will cause inter-channel interference due to unalignment of channel allocation with different channel widths.

In addition, to integrate sub-7 GHZ WLAN and IMMW operating in mmWave, the subcarrier spacing in IMMW is preferable to be a power of two (2) of the data field subcarrier spacing specified in IEEE 802.11be. However, the subcarrier spacing specified in 802.11ay does not equal a power of two of subcarrier spacing specified in IEEE 802.11be. Due to the reasons described above, it is required to design new tone plans for a given operating channel in IMMW, which are applied to the IEEE 802.11ay channelization and the subcarrier spacing, a power of two of the data field subcarrier spacing in IEEE 802.11be, with consideration of reusing IEEE 802.11be RU tone plans.

### C. Tone Plans and Guard Intervals for IMMW

In the following, various embodiments are described with an exemplary consideration of reusing 26-, 52-, 106-, 242-, 484- and 996-tone plans defined in IEEE 802.11be for integrating the MMW WLANs and sub-7 GHZ WLANs.

The embodiments disclosed therein provide designs on tone plans for IMMW by solving coexistence issue arise from prior arts and by integrating IMMW with sub-7 GHZ WLAN for complexity reduction. The embodiments disclosed therein are suitable for the IEEE 802.11ay channelization and the subcarrier spacing, with a power of two of the data field subcarrier spacing in IEEE 802.11be. The embodiments disclosed herein may be suitable for the standardization of next generation of IEEE 802.11 for operation on the unlicensed millimeter bands. The embodiments disclosed therein may be applicable to WI-FI® access points (APs) and stations (STAs) with operating capability in both sub-7 GHz and millimeter bands.

In some embodiments, tone plans in IMMW with subcarrier spacing of 2.5 MHz are used. In particular, the tone plans in IMMW have subcarrier spacing of 2.5 MHz (that is, Δ×2⁵ where Δ=78.125 kHz is the subcarrier spacing of EHT modulated fields) and channel widths of 2.16 GHZ, 4.32 GHZ, 6.48 GHz, and 8.64 GHz defined in the IEEE 802.11ay channelization. Channel widths of subchannels of 2.16 GHz in IEEE 802.11ay, such as 0.54 GHz and 1.08 GHZ which are considered in IEEE 802.11aj, are also taken into account. In these embodiments, the Tx spectral masks for 2.16 GHz, 4.32 GHZ, 6.48 GHz, and 8.64 GHz PPDU transmission in IEEE 802.11ay and the transmit spectrum masks for 0.54 GHz and 1.08 GHz PPDU transmission in IEEE 802.11aj are reused. Over-sampling operation is considered for reusing the IEEE 802.11ay channelization. Table 5 shows the design of tone plans for alternative operating channel BWs, wherein “dBr” is the abbreviation of “decibels relative to reference level”, “FFT” is the abbreviation of “fast Fourier transform”, “Opt” is the abbreviation of “Option”, “<=” represents “less than or equal to” (that is, “≤”), and “>=” represents “greater than or equal to” (that is, “≥”). Moreover, RUn refers to a group of n tones, which is an RU when it is shown on the left-hand side of “=”, or a group of n tones when it is shown on the right-hand side of “=” (that is, it is a part of the RU on the left-hand side of “=”, and may be used as a separate RU if needed).

For example, the representation “RU156=2×(RU52+RU26)” means that a 156-tone first RU (that is, RU156) is formed by two sets of tone groups, each set including a 52-tone group (RU52, which may be used a separate RU if needed) and a 26-tone group (RU26, which may be used a separate RU if needed).

Other alternative solutions are also readily available with the same channel BW, the same sampling rate, and subcarrier spacing.

TABLE 5
Tone plans for alternative operating channel BWs for subcarrier spacing of 2.5 MHz.

| | Sampling | | Subcarrier | |
|---|---|---|---|---|
| BW | rate | FFT | spacing | |
| (MHz) | (MHz) | size | (MHz) | MRU/tones |
| 540 | 640 | 256 | 2.5 | Opt 1: RU156 = 2 × (RU52 + RU26); 3 DC |
| | | | 188 tones in | Opt 2: not compliance with the 802.11be RU tone |
| | | | 0 dBr | plan: combination of data, pilot, DC and |
| | | | spectrum | guard tones <= 188 |
| 1080 | 1280 | 512 | 2.5 | Opt 1: RU346 = 2 × RU52 + RU242; 3 DC |
| | | | 376 tones in | Opt 2: not compliance with the 802.11be RU tone |
| | | | 0 dBr | plan: combination of data, pilot, DC and |
| | | | spectrum | guard tones <= 376 |
| 2160 | 2560 | 1024 | 2.5 | Opt 1: RU726 = 3 × RU242; 3 DC |
| | | | 735 tones in | Opt 2: RU696 = 2 × RU106 + RU484; 5 DC |
| | | | 0 dBr | Opt 3: not compliance with the 802.11be RU tone |
| | | | spectrum | plan: combination of data, pilot, DC and |
| | | | | guard tones <= 752 |
| 4320 | 5180 | 2048 | 2.5 | Opt 1: RU1584 = 2 × (RU52 + RU242) + RU996; |
| | | | 1616 tones in | 5 DC |
| | | | 0 dBr | Opt 2: RU1452 = 2 × RU726; >=3 DC |
| | | | spectrum | Opt 3: RU1392 = 2 × RU696; >=3 DC |
| | | | | Opt 4: not compliance with the 802.11be RU tone |
| | | | | plan: combination of data, pilot, DC and |
| | | | | guard tones <= 1616 |
| 6480 | 7680 | 3072 | 2.5 | Opt 1: RU2446 = 2 × RU106 + RU242 + 2 × RU996; |
| | | (that | 2480 tones | 3 DC |
| | | is, | in 0 dBr | Opt 2: RU2440 = 2 × RU26 + 4 × RU106 + |
| | | 3 × 2¹⁰) | spectrum | 2 × RU484 + RU996; 5 DC |
| | | | | Opt 3: RU2178 = 3 × RU726; 3 DC |
| | | | | Opt 4: RU2088 = 3 × RU696; 5 DC |
| | | | | Opt 5: not compliance with the 802.11be RU tone |
| | | | | plan: combination of data, pilot, DC and |
| | | | | guard tones <= 2480 |
| 8640 | 10240 | 4096 | 2.5 | Opt 1: RU3304 = 2 × RU52 + 2 × RU106 + |
| | | | 3344 tones in | 3 × RU996; 5 DC |
| | | | 0 dBr | Opt 2: RU2904 = 4 × RU726; >=3 DC |
| | | | spectrum | Opt 3: RU2784 = 4 × RU696; >=3 DC |
| | | | | Opt 4: not compliance with the 802.11be RU tone |
| | | | | plan: combination of data, pilot, DC and |
| | | | | guard tones <= 3344 |

As can be seen from Table 5, each tone group RUn (which may be an RU or a part of another RU) follows the RU definition as shown in FIG. 4. For example, RU26 contains 26 tones (including data tones and pilot tones; represented as “data/pilot tones” hereinafter). RU52 contains 52 data/pilot tones. RU106 contains two RU52's (that is, 2×RU52) with two null tones therebetween. RU242 contains two RU106's (that is, 2×RU106) with two null tones therebetween. RU484 contains two RU242's (that is, 2×RU242). RU996 contains two RU484's (that is, 2×RU484).

Generally, each tone group RUn in Table 5 may be a 26-tone group (RU26), or may be a tone group (such as a 52-tone group, 106-tone group, 242-tone group, 484-tone group, or 996-tone group) partitionable into a plurality of 26-tone groups (RU26's) with a plurality of two-tone groups that may be used as null tones, wherein each neighboring pair of the plurality of two-tone groups are spaced by one or more 26-tone groups (RU26's) of the plurality of 26-tone groups (RU26's).

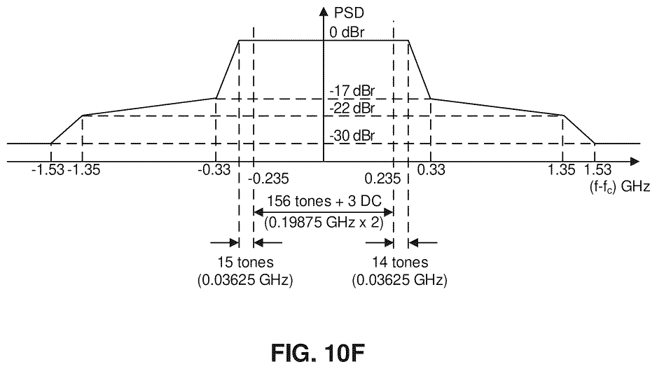

FIGS. 10A to 10F show some examples on IMMW tone plans listed in Table 5.

FIG. 10A shows the Tx spectral mask for channel BW of 2.16 GHz and the number of tones that may be allocated within the zero (0) dBr region and reuse the RU tone plans defined in IEEE 802.11be standard. In this example, the subcarrier spacing Δ=2.5 MHz with the sampling rate of 2560 MHz, and the DFT size equals to 1024 for channel BW of 2.16 GHz.

As shown in FIG. 10A, the 0 dBr region for 2.16 GHz BW is within [−0.94 GHZ, 0.94 GHz] (as defined in IEEE 802.11ay). The maximum number of tones allowed in the 0 dBr region [−0.94 GHZ, 0.94 GHz] is 940 MHz×2/Δ=752.

In this example, the RU tone plan in IMMW (BW=2160 MHz, DFT=1024, Δ=2.5 MHz) has three options:
Option 1 (reuse IEEE 802.11be RU tone plan):

$$RU 726 = 3 \times RU 242 ; 3 D C tones ( equivalent in size to the 484 + 242 - tone MRU defined in IEEE 802.11 be ) , that is , 729 tones = RU 242 + ( RU 242 + 3 D C tones ) + RU 242.$$

Option 2 (reuse 802.11be RU tone plan):

$$RU 696 = 2 \times RU 106 + R U 484 ; 5 D C tones , that is , 701 tones = RU 106 + ( R U 484 + 5 D C tones ) + RU 106.$$

Option 3 (may not be compliance with IEEE 802.11be RU tone plan): combination of possible data, pilot, DC, and guard tones, which are allocated in the 0 dBr region as shown in FIG. 10A with the total number of these tones less than or equal to 752.

FIG. 10B shows the Tx spectral mask for channel BW of 4.32 GHz and the number of tones that may be allocated within the zero (0) dBr region and reuse the RU tone plans defined in IEEE 802.11be standard. In this example, the subcarrier spacing Δ=2.5 MHz with the sampling rate of 5180 MHz. The DFT size equals to 2048 for channel BW of 4.32 GHz.

As shown in FIG. 10B, the 0 dBr region for channel BW of 4.32 GHz is within [−2.02 GHz, 2.02 GHz] (as defined in IEEE 802.11ay). The maximum number of tones allowed in the 0 dBr region [−2.02 GHZ, 2.02 GHz] is 2020 MHz×2/Δ=1616.

In this example, the RU tone plan in IMMW (BW=4320 MHz, DFT=2048, Δ=2.5 MHz) has four options:
Option 1 (reuse IEEE 802.11be RU tone plan):

$$RU 1584 = 2 \times ( RU 52 + RU 242 ) + R U 996 ; 5 D C tones , that is , 1589 tones = RU 52 + RU 242 + ( RU 996 + 5 D C tones ) + RU 242 + RU 52.$$

Option 2 (reuse IEEE 802.11be RU tone plan):

$$RU 1452 = 2 \times RU 726 ; >= 3 D C tones , that is , RU 726 + D C + RU 726 tones .$$

Option 3 (reuse IEEE 802.11be RU tone plan):

$$RU 1392 = 2 \times RU 696 ; >= 3 D C tones , that is , RU 696 + D C + R U 696 .$$

Option 4 (may not be compliance with IEEE 802.11be RU tone plan): combination of possible data, pilot, DC, and guard tones, which are allocated in the 0 dBr region as shown in FIG. 10B with the total number of these tones less than or equal to 1616.

FIG. 10C shows the Tx spectral mask for channel BW of 6.48 GHz and the number of tones that may be allocated within the zero (0) dBr region and reuse the RU tone plans defined in IEEE 802.11be standard. In this example, the subcarrier spacing Δ=2.5 MHz with the sampling rate of 7680 MHz. The DFT size equals to 3072 (=3×2¹⁰) for channel BW of 6.48 GHz.

As shown in FIG. 10C, the 0 dBr region for channel BW of 6.48 GHz is within [−3.10 GHz, 3.10 GHz] (as defined in IEEE 802.11ay). The maximum number of tones allowed in the 0 dBr region [−3.10 GHz, 3.10 GHz] is 3100 MHz×2/Δ=2480.

In this example, the RU tone plan in IMMW (BW=6480 MHz, DFT=3072, Δ=2.5 MHz) has five options:
Option 1 (reuse IEEE 802.11be RU tone plan):

$$RU 2446 = 2 \times RU 106 + RU 242 + 2 \times RU 996 tones ; 3 D C tones , that is , 2449 tones = RU 106 + RU 996 + ( RU 242 + 3 D C tones ) + RU 996 + RU 106.$$

Option 2 (reuse IEEE 802.11be RU tone plan):

$$R U 2440 = 2 \times R U 26 + 4 \times RU 106 + 2 \times R U 484 + R U 996 ; 5 D C tones , that is , 2445 tones = RU 26 + RU 106 + RU 106 + R U 4 \; 84 + ( RU 996 + 5 D C tones ) + RU 484 + RU 106 + RU 106 + RU 26.$$

Option 3 (reuse IEEE 802.11be RU tone plan):

$$RU 2178 = 3 \times RU 726 ; 3 D C tones , that is , 2181 tones = RU 726 + ( RU 726 + 3 D C tones ) + RU 726.$$

Option 4 (reuse IEEE 802.11be RU tone plan):

$$R U 2088 = 3 \times R U 696 ; 5 D C tones , that is , 2093 tones = RU 696 + ( RU 696 + 5 D C tones ) + RU 696.$$

Option 5 (may not be compliance with IEEE 802.11be RU tone plan): combination of possible data, pilot, DC, and guard tones, which are allocated in the 0 dBr region as shown FIG. 10C with the total number of these tones less than or equal to 2480.

FIG. 10D shows the Tx spectral mask for channel BW of 8.64 GHz and the number of tones that may be allocated within the zero (0) dBr region and reuse the RU tone plans defined in IEEE 802.11be standard. In this example, the subcarrier spacing Δ=2.5 MHz with the sampling rate of 10240 MHz. The DFT size equals to 4096 for channel BW of 8.64 GHz.

As shown in FIG. 10D, the 0 dBr region for channel BW of 8.64 GHz is within [−4.18 GHz, 4.18 GHz] (as defined in IEEE 802.11ay). The maximum number of tones allowed in the 0 dBr region [−4.18 GHZ, 4.18 GHz] is 4180 MHz×2/Δ=3344.

In this example, the RU tone plan in IMMW (BW=8640 MHz, DFT=4096, Δ=2.5 MHz) has five options:
Option 1 (reuse IEEE 802.11be RU tone plan):

$$R U 3304 = 2 \times RU 52 + 2 \times RU 106 + 3 \times R U 996 ; 5 D C tones , that is , 3309 tones = RU 52 + RU 106 + R U 9 \; 96 + ( RU 996 + 5 D C tones ) + RU 996 + RU 106 + RU 52.$$

Option 2 (reuse IEEE 802.11be RU tone plan):

$$R U 2904 = 4 \times RU 726 ; >= 3 D C tones , that is , RU 726 + RU 726 + D C tones + RU 726 + RU 726.$$

Option 3 (reuse IEEE 802.11be RU tone plan):

$$RU 2784 = 4 \times RU 696 ; >= 3 D C tones , that is , RU 696 + R U 696 + D C tones + RU 696 + RU 696.$$

Option 4 (may not be compliance with IEEE 802.11be RU tone plan): combination of possible data, pilot, DC, and guard tones, which are allocated in the 0 dBr region as shown in FIG. 10D with the total number of these tones less than or equal to 3344.

FIG. 10E shows the Tx spectral mask for channel BW of 1.08 GHz and the number of tones that may be allocated within the zero (0) dBr region and reuse the RU tone plans defined in IEEE 802.11be standard. In this example, the subcarrier spacing Δ=2.5 MHz with the sampling rate of 1280 MHz. The DFT size equals to 512 for channel BW of 1.08 GHz.

As shown in FIG. 10E, the 0 dBr region for channel BW of 1.08 GHz is within [−0.47 GHz, 0.47 GHz] (as defined in IEEE 802.11aj). The maximum number of tones allowed in the 0 dBr region [−0.47 GHZ, 0.47 GHz] is 470 MHz×2/Δ=376.

In this example, the RU tone plan in IMMW (BW=1080 MHz, DFT=512, Δ=2.5 MHz) has two options:
Option 1 (reuse IEEE 802.11be RU tone plan):

$$RU 346 = 2 \times RU 52 + RU 242 ; 3 D C tones , that is , 349 tones are arranged as : RU 52 + ( RU 242 + 3 D C tones ) + RU 52.$$

Option 2 (may not be compliance with IEEE 802.11be RU tone plan): combination of possible data, pilot, DC, and guard tones, which are allocated in the 0 dBr region as shown in FIG. 10E with the total number of these tones less than or equal to 376.

FIG. 10F shows the Tx spectral mask for channel BW of 0.54 GHz and the number of tones that may be allocated within the zero (0) dBr region and reuse the RU tone plans defined in IEEE 802.11be standard. In this example, the subcarrier spacing Δ=2.5 MHz with the sampling rate of 640 MHz. The DFT size equals to 256 for channel BW of 0.54 GHz.

As shown in FIG. 10F, the 0 dBr region for channel BW of 0.54 GHz is within [−0.235 GHz, 0.235 GHz] (as defined in IEEE 802.11aj). The maximum number of tones allowed in the 0 dBr region [−0.235 GHZ, 0.235 GHz] is 235 MHz×2/Δ=188.

In this example, the RU tone plan in IMMW (BW=540 MHz, DFT=256, Δ=2.5 MHz) has two options:
Option 1 (reuse IEEE 802.11be RU tone plan):

$$RU 156 = 2 \times ( RU 52 + RU 26 ) ; 3 D C tones , that is , 161 tones = RU 26 + RU 52 + 3 D C + RU 52 + RU 26.$$

Option 2 (may not be compliance with IEEE 802.11be RU tone plan): combination of possible data, pilot, DC, and guard tones, which are allocated in the 0 dBr region as shown in FIG. 10E with the total number of these tones to be less than or equal to 188.

In some embodiments, tone plans in IMMW with subcarrier spacing of 5 MHz (that is, Δ×26 where Δ=78.125 kHz is the subcarrier spacing of EHT modulated fields) are used for channel widths of 2.16 GHZ, 4.32 GHZ, 6.48 GHz and 8.64 GHz defined in IEEE 802.11ay channelization. Channel widths of subchannels of 2.16 GHz in 802.11ay, such as 0.54 GHz and 1.08 GHz which are considered in 802.11aj, are also taken into account. The Tx spectral masks for 2.16 GHZ, 4.32 GHZ, 6.48 GHz and 8.64 GHz PPDU transmission in IEEE 802.11ay and the transmit spectrum masks for 0.54 GHz and 1.08 GHz PPDU transmission in IEEE 802.11aj are reused. Over-sampling operation is considered for reusing the IEEE 802.11ay channelization.

Table 6 shows the tone plans for alternative operating channel BWs for subcarrier spacing of 5 MHz.

TABLE 6
Tone plans for alternative operating channel BWs for subcarrier spacing of 5 MHz.

| | Sampling | | Subcarrier | |
|---|---|---|---|---|
| BW | rate | FFT | spacing | |
| (MHz) | (MHz) | size | (MHz) | MRU/tones |
| 540 | 640 | 128 | 5 | Opt 1: RU78 =3 × RU26; 3 DC |
| | | | 94 tones in 0 | Opt 2: not compliance with the 802.11be RU tone |
| | | | dBr spectrum | plan: combination of data, pilot, DC and |
| | | | | guard tones <= 94 |
| 1080 | 1280 | 256 | 5 | Opt 1: RU156 = 2 × (RU52 + RU26); >=3 DC |
| | | | 188 tones in | Opt 2: not compliance with the 802.11be RU tone |
| | | | 0 dBr | plan: combination of data, pilot, DC and |
| | | | spectrum | guard tones <= 188 |
| 2160 | 2560 | 512 | 5 | Opt 1: RU346 = 2 × RU52 + RU242; 3 DC |
| | | | 376 tones in | Opt 2: not compliance with the 802.11be RU tone |
| | | | 0 dBr | plan: combination of data, pilot, DC and |
| | | | spectrum | guard tones <= 376 |
| 4320 | 5180 | 1024 | 5 | Opt 1: RU778 = 3 × RU242 + 2 × RU26; 3 DC |
| | | | 808 tones in | Opt 2: RU748 = 2 × RU26 + 2 × RU106 + RU484; |
| | | | 0 dBr | 5 DC |
| | | | spectrum | Opt 3: RU692 = 2 × RU346; >=3 DC |
| | | | | Opt 4: not compliance with the 802.11be RU tone |
| | | | | plan: combination of data, pilot, DC and |
| | | | | guard tones <= 808 |
| 6480 | 7680 | 1536 | 5 | Opt 1: RU1208 = 2 × RU106 + RU996; 5 DC |
| | | (that | 1240 tones in | Opt 2: RU1038 = 3 × RU346; 3 DC |
| | | is, | 0 dBr | Opt 3: not compliance with the 802.11be RU tone |
| | | 3 × 2⁹) | spectrum | plan: combination of data, pilot, DC and |
| | | | | guard tones <= 1240 |
| 8640 | 10240 | 2048 | 5 | Opt 1: RU1636 = 2 × (26 + 52 + 242) + 959; 5 DC |
| | | | 1672 tones in | Opt 2: 4 × RU346; >=3 DC |
| | | | 0 dBr | Opt 3: not compliance with the 802.11be RU tone |
| | | | spectrum | plan: combination of data, pilot, DC and |
| | | | | guard tones <= 1672 |

In some embodiments, tone plans in IMMW with subcarrier spacing of 1.25 MHz (that is, Δ×2⁴ where Δ=78.125 kHz is the subcarrier spacing of EHT modulated fields) are used for channel widths of 2.16 GHZ, 4.32 GHZ, 6.48 GHZ, and 8.64 GHz defined in IEEE 802.11ay channelization. Channel widths of subchannels of 2.16 GHz in IEEE 802.11ay, such as 0.54 GHz and 1.08 GHz which are considered in IEEE 802.11aj, are also taken into account. The Tx spectral masks for 2.16 GHZ, 4.32 GHZ, 6.48 GHz, and 8.64 GHz PPDU transmission in IEEE 802.11ay and the transmit spectrum masks for 0.54 GHz and 1.08 GHz PPDU transmission in IEEE 802.11aj are reused. Over-sampling operation is considered for reusing IEEE 802.11ay channelization.

Table 7 shows the tone plans for alternative operating channel BWs for subcarrier spacing of 1.25 MHz.

TABLE 7
Tone plans for alternative operating channel BWs for subcarrier spacing of 1.25 MHz.

| | Sampling | | Subcarrier | |
|---|---|---|---|---|
| BW | rate | FFT | spacing | |
| (MHz) | (MHz) | size | (MHz) | MRU/tones |
| 540 | 640 | 512 | 1.25 | Opt 1: RU346 = 2 × RU52 + RU242; 3 DC |
| | | | 376 tones in | Opt 2: not compliance with the 802.11be RU tone |
| | | | 0 dBr | plan: combination of data, pilot, DC and |
| | | | spectrum | guard tones <= 376 |
| 1080 | 1280 | 1024 | 1.25 | Opt 1: RU726 = 3 × RU242; 3 DC |
| | | | 752 tones in | Opt 2: RU696 = 2 × RU106 + RU484; 5 DC |
| | | | 0 dBr | Opt 3: RU692 = 2 × RU346; 3DC |
| | | | spectrum | Opt 4: not compliance with the 802.11be RU tone |
| | | | | plan: combination of data, pilot, DC and |
| | | | | guard tones <= 752 |
| 2160 | 2560 | 2048 | 1.25 | Opt 1: RU1480 = 2 × 242 + 996; 5 DC |
| | | | 1504 tones in | Opt 2: RU1452 = 2 × RU726; >=3 DC |
| | | | 0 dBr | Opt 3: RU1384 = 4 × RU346; >=3 DC |
| | | | spectrum | Opt 4: not compliance with the 802.11be RU tone |
| | | | | plan: combination of data, pilot, DC and |
| | | | | guard tones <= 1504 |
| 4320 | 5180 | 4096 | 1.25 | Opt 1: RU3200 = 2 × 106 + 3 × 996; 5 DC |
| | | | 3232 tones in | Opt 2: RU2904 = 4 × RU726; >=3 DC |
| | | | 0 dBr | Opt 3: RU2960 = 2 × RU1480; >=3 DC |
| | | | spectrum | Opt 4: not compliance with the 802.11be RU tone |
| | | | | plan: combination of data, pilot, DC and |
| | | | | guard tones <= 3232 |
| 6480 | 7680 | 6144 | 1.25 | Opt 1: RU4922 = |
| | | (that | 4960 tones in | 2 × RU106 + 3 × RU242 + 4 × RU996; 3 DC |
| | | is, | 0 dBr | Opt 2: RU4440 = 3 × RU1480; 5 DC |
| | | 3 × 2¹¹) | spectrum | Opt 3: not compliance with the 802.11be RU tone |
| | | | | plan: combination of data, pilot, DC and |
| | | | | guard tones <= 4960 |
| 8640 | 10240 | 8192 | 1.25 | Opt 1: RU6672 = 2 × (106 + 242) + 6 × 996; >=3 |
| | | | 6688 tones in | DC |
| | | | 0 dBr | Opt 2: 4 × RU1480; 5 DC |
| | | | spectrum | Opt 3: not compliance with the 802.11be RU tone |
| | | | | plan: combination of data, pilot, DC and |
| | | | | guard tones <= 6688 |

In some embodiments, tone plans in IMMW with subcarrier spacing of 0.625 MHz (that is, Δ×2³ where Δ=78.125 kHz is the subcarrier spacing of EHT modulated fields) are used for channel widths of 2.16 GHZ, 4.32 GHZ, 6.48 GHz, and 8.64 GHz defined in IEEE 802.11ay channelization. Channel widths of subchannels of 2.16 GHz in IEEE 802.11ay, such as 0.54 GHz and 1.08 GHz which are considered in IEEE 802.11aj, are also taken into account. The Tx spectral masks for 2.16 GHZ, 4.32 GHZ, 6.48 GHz, and 8.64 GHz PPDU transmission in IEEE 802.11ay and the transmit spectrum masks for 0.54 GHz and 1.08 GHz PPDU transmission in IEEE 802.11aj are reused. Over-sampling operation is considered for reusing IEEE 802.11ay channelization.

Table 8 shows the design of tone plans for alternative operating channel BWs for subcarrier spacing of 0.625 MHz.

TABLE 8
Tone plans for alternative operating channel BWs for subcarrier spacing of 0.625 MHz.

| | Sampling | | Subcarrier | |
|---|---|---|---|---|
| BW | rate | FFT | spacing | |
| (MHz) | (MHz) | size | (MHz) | MRU/tones |
| 540 | 640 | 1024 | 0.625 | Opt 1: RU726 = 3 × RU242; 3 DC |
| | | | 752 tones in | Opt 2: RU696 = 2 × RU106 + RU484; 5 DC |
| | | | 0 dBr | Opt 3: not compliance with the 802.11be RU tone |
| | | | spectrum | plan: combination of data, pilot, DC and |
| | | | | guard tones <= 752 |
| 1080 | 1280 | 2048 | 0.625 | Opt 1: RU1480 = 2 × RU242 + RU996; 5 DC |
| | | | 1504 tones in | Opt 2: RU1452 = 2 × RU726; >=3 DC |
| | | | 0 dBr | Opt 3: not compliance with the 802.11be RU tone |
| | | | spectrum | plan: combination of data, pilot, DC and |
| | | | | guard tones <= 1504 |
| 2160 | 2560 | 4096 | 0.625 | Opt 1: RU2988 = 3 × RU996; 5 DC |
| | | | 3008 tones | Opt 2: RU2960 = 2 × RU1480; >=3 DC |
| | | | in 0 dBr | Opt 3: not compliance with the 802.11be RU tone |
| | | | spectrum | plan: combination of data, pilot, DC and |
| | | | | guard tones <= 3008 |
| 4320 | 5180 | 8192 | 0.625 | Opt 1: RU6444 = 2 × RU26 + 8 × RU52 + 6 × |
| | | | 6464 tones in | RU996; >=3 DC |
| | | | 0 dBr | Opt 2: RU5976 = 2 × RU2988; >=3 DC |
| | | | spectrum | Opt 3: not compliance with the 802.11be RU tone |
| | | | | plan: combination of data, pilot, DC and |
| | | | | guard tones <= 6464 |
| 6480 | 7680 | 16384 | 0.625 | Opt 1: RU9868 = 4 × RU52 + 2 × RU106 + 2 × |
| | | | 9920 tones in | RU242 + 9 × RU996; 3 DC |
| | | | 0 dBr | Opt 2: not compliance with the 802.11be RU tone |
| | | | spectrum | plan: combination of data, pilot, DC and |
| | | | | guard tones <= 9920 |
| 8640 | 10240 | 32768 | 0.625 | Opt 1: RU13368 = 4 × RU52 + 2 × RU106 + |
| | | | 13376 tones | 13 × RU996; 5 DC |
| | | | in 0 dBr | Opt 2: RU13360 = 2 × RU6444 + 2 × RU106 + |
| | | | spectrum | 4 × RU52 + 2 × RU26; >=3 DC |
| | | | | Opt 3: not compliance with the 802.11be RU tone |
| | | | | plan: combination of data, pilot, DC and |
| | | | | guard tones <= 13376 |

Table 9 shows the lengths of the guard intervals for each channel width with subcarrier spacing of 2.5 MHz in IMMW, according to some embodiments of this disclosure.

TABLE 9
GIs in IMMW with subcarrier spacing of 2.5 MHz.

| | BW/sampling rate (GHz) | | | | | | | | | | | |
|---|---|---|---|---|---|---|---|---|---|---|---|---|
| Parameters | 0.54/0.64 | | 1.08/1.28 | | 2.16/2.56 | | 4.32/5.12 | | 6.48/7.68 | | 8.64/10.24 | |
| Subcarrier | 2.5 | MHz | 2.5 | MHz | 2.5 | MHz | 2.5 | MHz | 2.5 | MHz | 2.5 | MHz |
| frequency | | | | | | | | | | | | |
| spacing | | | | | | | | | | | | |
| DFT size | 256 | | 512 | | 1024 | | 2048 | | 3072 | | 4096 | |
| OFDM | 400 | ns | 400 | ns | 400 | ns | 400 | ns | 400 | ns | 400 | ns |

| | | | | | | |
|---|---|---|---|---|---|---|
| IDFT/DFT period | | | | | | |
| GI1 length/ | 8/12.5 ns/ | 16/12.5 ns/ | 32/12.5 ns/ | 64/12.5 ns/ | 96/12.5 ns/ | 128/12.5 ns/ |
| duration/ | 3.125% | 3.125% | 3.125% | 3.125% | 3.125% | 3.125% |
| percentage of GI | | | | | | |
| vs OFDM symbol | | | | | | |
| GI2 length/ | 16/25 ns/ | 32/25 ns/ | 64/25 ns/ | 128/25 ns/ | 192/25 ns/ | 256/25 ns/ |
| duration/ | 6.25% | 6.25% | 6.25% | 6.25% | 6.25% | 6.25% |
| percentage of GI | | | | | | |
| vs OFDM symbol | | | | | | |
| GI3 length/ | 32/50 ns/ | 64/50 ns/ | 128/50 ns/ | 256/50 ns/ | 384/50 ns/ | 512/50 ns/ |
| duration/ | 12.5% | 12.5% | 12.5% | 12.5% | 12.5% | 12.5% |
| percentage of GI | | | | | | |
| vs OFDM symbol | | | | | | |
| GI4 length/ | 64/100 ns/ | 128/100 ns/ | 256/100 ns/ | 512/100 ns/ | 768/100 ns/ | 1024/100 ns/ |
| duration/ | 25% | 25% | 25% | 25% | 25% | 25% |
| percentage of GI | | | | | | |
| vs OFDM symbol | | | | | | |

Table 10 shows the lengths of the guard intervals for each channel width with subcarrier spacing of 5 MHz in IMMW, according to some embodiments of this disclosure.

TABLE 10
GIs in IMMW with subcarrier spacing of 5 MHz.

| | BW/sampling rate (GHz) | | | | | | | | | | | |
|---|---|---|---|---|---|---|---|---|---|---|---|---|
| Parameters | 0.54/0.64 | | 1.08/1.28 | | 2.16/2.56 | | 4.32/5.12 | | 6.48/7.68 | | 8.64/10.24 | |
| Subcarrier | 5 | MHz | 5 | MHz | 5 | MHz | 5 | MHz | 5 | MHz | 5 | MHz |
| frequency | | | | | | | | | | | | |
| spacing | | | | | | | | | | | | |
| DFT size | 128 | | 256 | | 512 | | 1024 | | 1536 | | 2048 | |
| OFDM | 200 | ns | 200 | ns | 200 | ns | 200 | ns | 200 | ns | 200 | ns |

| | | | | | | |
|---|---|---|---|---|---|---|
| IDFT/DFT period | | | | | | |
| GI1 length/ | 8/12.5 ns/ | 16/12.5 ns/ | 32/12.5 ns/ | 64/12.5 ns/ | 96/12.5 ns/ | 128/12.5 ns/ |
| duration/ | 6.25% | 6.25% | 6.25% | 6.25% | 6.25% | 6.25% |
| percentage of GI | | | | | | |
| vs OFDM symbol | | | | | | |
| GI2 length/ | 16/25 ns/ | 32/25 ns/ | 64/25 ns/ | 128/25 ns/ | 192/25 ns/ | 256/25 ns/ |
| duration/ | 12.5% | 12.5% | 12.5% | 12.5% | 12.5% | 12.5% |
| percentage of GI | | | | | | |
| vs OFDM symbol | | | | | | |
| GI3 length/ | 32/50 ns/ | 64/50 ns/ | 128/50 ns/ | 256/50 ns/ | 384/50 ns/ | 512/50 ns/ |
| duration/ | 25% | 25% | 25% | 25% | 25% | 25% |
| percentage of GI | | | | | | |
| vs OFDM symbol | | | | | | |
| GI4 length/ | 48/75 ns/ | 96/75 ns/ | 192/75 ns/ | 384/75 ns/ | 576/75 ns/ | 768/75 ns/ |
| duration/ | 37.5% | 37.5% | 37.5% | 37.5% | 37.5% | 37.5% |
| percentage of GI | | | | | | |
| vs OFDM symbol | | | | | | |

Table 11 shows the lengths of the guard intervals for each channel width with subcarrier spacing of 1.25 MHz in IMMW, according to some embodiments of this disclosure.

TABLE 11
GIs in IMMW with subcarrier spacing of 1.25 MHz.

| | BW/sampling rate (GHz) | | | | | | | | | | | |
|---|---|---|---|---|---|---|---|---|---|---|---|---|
| Parameters | 0.54/0.64 | | 1.08/1.28 | | 2.16/2.56 | | 4.32/5.12 | | 6.48/7.68 | | 8.64/10.24 | |
| Subcarrier | 1.25 | MHz | 1.25 | MHz | 1.25 | MHz | 1.25 | MHz | 1.25 | MHz | 1.25 | MHz |
| frequency | | | | | | | | | | | | |
| spacing | | | | | | | | | | | | |
| DFT size | 512 | | 1024 | | 2048 | | 4096 | | 6144 | | 8192 | |
| OFDM | 800 | ns | 800 | ns | 800 | ns | 800 | ns | 800 | ns | 800 | ns |

| | | | | | | |
|---|---|---|---|---|---|---|
| IDFT/DFT period | | | | | | |
| GI1 length/ | 8/12.5 ns/ | 16/12.5 ns/ | 32/12.5 ns/ | 64/12.5 ns/ | 96/12.5 ns/ | 128/12.5 ns/ |
| duration/ | 1.56% | 1.56% | 1.56% | 1.56% | 1.56% | 1.56% |
| percentage of GI | | | | | | |
| vs OFDM symbol | | | | | | |
| GI2 length/ | 16/25 ns/ | 32/25 ns/ | 64/25 ns/ | 128/25 ns/ | 192/25 ns/ | 256/25 ns/ |
| duration/ | 3.125% | 3.125% | 3.125% | 3.125% | 3.125% | 3.125% |
| percentage of GI | | | | | | |
| vs OFDM symbol | | | | | | |
| GI3 length/ | 32/50 ns/ | 64/50 ns/ | 128/50 ns/ | 256/50 ns/ | 384/50 ns/ | 512/50 ns/ |
| duration/ | 6.25% | 6.25% | 6.25% | 6.25% | 6.25% | 6.25% |
| percentage of GI | | | | | | |
| vs OFDM symbol | | | | | | |
| GI4 length/ | 64/100 ns/ | 128/100 ns/ | 256/100 ns/ | 512/100 ns/ | 768/100 ns/ | 1024/100 ns/ |
| duration/ | 12.5% | 12.5% | 12.5% | 12.5% | 12.5% | 12.5% |
| percentage of GI | | | | | | |
| vs OFDM symbol | | | | | | |

Table 12 shows the lengths of the guard intervals for each channel width with subcarrier spacing of 0.625 MHz in IMMW, according to some embodiments of this disclosure.

TABLE 12
GIs in IMMW with subcarrier spacing of 0.625 MHz.

| | BW/sampling rate (GHz) | | | | | | | | | | | |
|---|---|---|---|---|---|---|---|---|---|---|---|---|
| Parameters | 0.54/0.64 | | 1.08/1.28 | | 2.16/2.56 | | 4.32/5.12 | | 6.48/7.68 | | 8.64/10.24 | |
| Subcarrier | 0.625 | MHz | 0.625 | MHz | 0.625 | MHz | 0.625 | MHz | 0.625 | MHz | 0.625 | MHz |
| frequency | | | | | | | | | | | | |
| spacing | | | | | | | | | | | | |
| DFT size | 1024 | | 2048 | | 4096 | | 8192 | | 12288 | | 16384 | |
| OFDM | 1600 | ns | 1600 | ns | 1600 | ns | 1600 | ns | 1600 | ns | 1600 | ns |

| | | | | | | |
|---|---|---|---|---|---|---|
| IDFT/DFT period | | | | | | |
| GI1 length/ | 8/12.5 ns/ | 16/12.5 ns/ | 32/12.5 ns/ | 64/12.5 ns/ | 96/12.5 ns/ | 128/12.5 ns/ |
| duration/ | 0.78% | 0.78% | 0.78% | 0.78% | 0.78% | 0.78% |
| percentage of GI | | | | | | |
| vs OFDM symbol | | | | | | |
| GI2 length/ | 16/25 ns/ | 32/25 ns/ | 64/25 ns/ | 128/25 ns/ | 192/25 ns/ | 256/25 ns/ |
| duration/ | 1.56% | 1.56% | 1.56% | 1.56% | 1.56% | 1.56% |
| percentage of GI | | | | | | |
| vs OFDM symbol | | | | | | |
| GI3 length/ | 32/50 ns/ | 64/50 ns/ | 128/50 ns/ | 256/50 ns/ | 384/50 ns/ | 512/50 ns/ |
| duration/ | 3.125% | 3.125% | 3.125% | 3.125% | 3.125% | 3.125% |
| percentage of GI | | | | | | |
| vs OFDM symbol | | | | | | |
| GI4 length/ | 64/100 ns/ | 128/100 ns/ | 256/100 ns/ | 512/100 ns/ | 768/100 ns/ | 1024/100 ns/ |
| duration/ | 6.25% | 6.25% | 6.25% | 6.25% | 6.25% | 6.25% |
| percentage of GI | | | | | | |
| vs OFDM symbol | | | | | | |

In above embodiments, various tone plans and GI lengths for IMMW and methods of using same are disclosed for reuse IEEE 802.11be RU tone plan to integrate IMMW with sub-7 GHz WLAN and to ensure co-existence of IMMW with 802.11ay and 802.11bf to minimize inter-channel interference.

In some embodiments, the tone plans and GI lengths for IMMW disclosed herein may be specified in one or more standards such as one or more IEEE standards.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments of tone plans and GI lengths for IMMW and methods of using same are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

1. A communication method comprising:
transmitting to a device or receiving from the device a signal in a millimeter wave (MMW) band using a resource unit (RU) in an orthogonal frequency-division multiple access (OFDMA) physical layer protocol data unit (PPDU),
wherein the RU is one of a plurality of RUs of the OFDMA PPDU,
wherein the MMW band has a bandwidth of 0.54 Gigahertz (GHz), 1.08 GHZ, 2.16 GHZ, 4.32 GHZ, 6.48 GHz, or 8.64 GHz, and
wherein the plurality of RUs comprises one or more 26-subcarrier RUs, one or more 52-subcarrier RUs, one or more 106-subcarrier RUs, one or more 242-subcarrier RUs, one or more 484-subcarrier RUs, one or more 996-subcarrier RUs, or a combination thereof.

2. The communication method of claim 1, wherein the one or more 26-subcarrier RUs, the one or more 52-subcarrier RUs, the one or more 106-subcarrier RUs, the one or more 242-subcarrier RUs, the one or more 484-subcarrier RUs, the one or more 996-subcarrier RUs, or the combination corresponds to RUs defined in IEEE 802.11be.

3. The communication method of claim 1, wherein the plurality of RUs is in a zero decibels relative to reference level (dBr) region of the MMW band.

4. The communication method of claim 1, wherein each RU of the plurality of RUs is partitionable to a plurality of 26-subcarrier groups separated by a plurality of null-subcarrier groups, and wherein each of the plurality of null-subcarrier groups contains two subcarriers.

5. The communication method of claim 1, wherein each RU of the plurality of RUs is partitionable to a plurality of 26-subcarrier groups separated by a plurality of null-subcarrier groups, wherein each neighboring pair of the plurality of null-subcarrier groups are spaced by one or more 26-subcarrier groups of the plurality of 26-subcarrier groups.

6. The communication method of claim 1, wherein the MMW band has the bandwidth of 0.54 GHz, and the OFDMA PPDU has a sampling rate of 640 Megahertz (MHz), a discrete Fourier transform (DFT) size of 256, and a subcarrier spacing of 2.5 MHz; and
wherein the plurality of RUs contains 156 subcarriers on opposite frequency sides of three direct-current (DC) subcarriers and partitionable to two 52-subcarrier groups and two 26-subcarrier groups, or
a total number of the plurality of RUs and one or more DC subcarriers is less than or equal to 188.

7. The communication method of claim 6, wherein the signal comprises an orthogonal frequency division multiplexing (OFDM) symbol and a guard interval having a length being one of 8, 16, 32, or 64.

8. The communication method of claim 1, wherein the MMW band has the bandwidth of 1.08 GHZ, and the OFDMA PPDU has a sampling rate of 1280 MHz, a DFT size of 512, and a subcarrier spacing of 2.5 MHz; and
wherein the plurality of RUs contains 346 subcarriers on opposite frequency sides of three DC subcarriers and partitionable to two 52-subcarrier groups and one 242-subcarrier group, or
a total number of the plurality of RUs and one or more DC subcarriers is less than or equal to 376.

9. The communication method of claim 8, wherein the signal comprises an OFDM symbol and a guard interval having a length being one of 16, 32, 64, or 128.

10. The communication method of claim 1, wherein the MMW band has the bandwidth of 2.16 GHZ, and the OFDMA PPDU has a sampling rate of 2560 MHz, a DFT size of 1024, and a subcarrier spacing of 2.5 MHz; and
wherein the plurality of RUs contains 726 subcarriers on opposite frequency sides of three DC subcarriers and partitionable to three 242-subcarrier groups,
the plurality of RUs contains 696 subcarriers on opposite frequency sides of five DC subcarriers and partitionable to two 106-subcarrier groups and one 484-subcarrier group, or
a total number of the plurality of RUs and one or more DC subcarriers is less than or equal to 752.

11. A communication apparatus, comprising at least one processor and a memory, wherein the memory stores program code, and the processor invokes the program code stored in the memory to cause the communication apparatus to perform operations including:
transmitting to a device or receiving from the device a signal in a millimeter wave (MMW) band using a resource unit (RU) in an orthogonal frequency-division multiple access (OFDMA) physical layer protocol data unit (PPDU),
wherein the RU is one of a plurality of RUs of the OFDMA PPDU,
wherein the MMW band has a bandwidth of 0.54 Gigahertz (GHz), 1.08 GHZ, 2.16 GHZ, 4.32 GHz, 6.48 GHz, or 8.64 GHz, and
wherein the plurality of RUs comprises one or more 26-subcarrier RUs, one or more 52-subcarrier RUs, one or more 106-subcarrier RUs, one or more 242-subcarrier RUs, one or more 484-subcarrier RUs, one or more 996-subcarrier RUs, or a combination thereof.

12. The communication apparatus of claim 11, wherein the one or more 26-subcarrier RUS, the one or more 52-subcarrier RUs, the one or more 106-subcarrier RUs, the one or more 242-subcarrier RUs, the one or more 484-subcarrier RUs, the one or more 996-subcarrier RUs, or the combination correspond to RUs defined in IEEE 802.11be.

13. The communication apparatus of claim 11, wherein the plurality of RUs is in a zero decibels relative to reference level (dBr) region of the MMW band.

14. The communication apparatus of claim 11, wherein each RU of the plurality of RUs is partitionable to a plurality of 26-subcarrier groups separated by a plurality of null-subcarrier groups, and wherein each of the plurality of null-subcarrier groups contains two subcarriers.

15. The communication apparatus of claim 11, wherein each RU of the plurality of RUs is partitionable to a plurality of 26-subcarrier groups separated by a plurality of null-subcarrier groups, and wherein each neighboring pair of the plurality of null-subcarrier groups are spaced by one or more 26-subcarrier groups of the plurality of 26-subcarrier groups.

16. The communication apparatus of claim 11, wherein the MMW band has the bandwidth of 0.54 GHZ, and the OFDMA PPDU has a sampling rate of 640 Megahertz (MHz), a discrete Fourier transform (DFT) size of 256, and a subcarrier spacing of 2.5 MHz; and
wherein the plurality of RUs contains 156 subcarriers on opposite frequency sides of three direct-current (DC) subcarriers and partitionable to two 52-subcarrier groups and two 26-subcarrier groups, or
a total number of the plurality of RUs and one or more DC subcarriers is less than or equal to 188.

17. The communication apparatus of claim 16, wherein the signal comprises an orthogonal frequency division multiplexing (OFDM) symbol and a guard interval having a length being one of 8, 16, 32, or 64.

18. The communication apparatus of claim 11, wherein the MMW band has the bandwidth of 1.08 GHZ, and the OFDMA PPDU has a sampling rate of 1280 MHz, a DFT size of 512, and a subcarrier spacing of 2.5 MHz; and
wherein the plurality of RUs contains 346 subcarriers on opposite frequency sides of three DC subcarriers and partitionable to two 52-subcarrier groups and one 242-subcarrier group, or
a total number of the plurality of RUs and one or more DC subcarriers is less than or equal to 376.

19. The communication apparatus of claim 18, wherein the signal comprises an OFDM symbol and a guard interval having a length being one of 16, 32, 64, or 128.

20. The communication apparatus of claim 11, wherein the MMW band has the bandwidth of 2.16 GHz, and the OFDMA PPDU has a sampling rate of 2560 MHz, a DFT size of 1024, and a subcarrier spacing of 2.5 MHz; and
wherein the plurality of RUs contains 726 subcarriers on opposite frequency sides of three DC subcarriers and partitionable to three 242-subcarrier groups,
the plurality of RUs contains 696 subcarriers on opposite frequency sides of five DC subcarriers and partitionable to two 106-subcarrier groups and one 484-subcarrier group, or
a total number of the plurality of RUs and one or more DC subcarriers is less than or equal to 752.
